(19) United States
(12) Patent Application Publication
(10) Pub. No.: US 2015/0127360 A1
(43) Pub. Date: May 7, 2015

(54) METHOD, APPARATUS, SYSTEM, AND COMPUTER READABLE MEDIUM FOR PROVIDING REFERRAL SERVICES

(71) Applicant: PHYSICIAN REFERRAL NETWORK, LLC, Overland Park, KS (US)

(72) Inventors: David S. Dyer, Olathe, KS (US); James W. Higgins, Overland Park, KS (US)

(73) Assignee: PHYSICIAN REFERRAL NETWORK, LLC, Overland Park, KS (US)

(21) Appl. No.: 14/396,854

(22) PCT Filed: Apr. 29, 2013
(86) PCT No.: PCT/US13/38595

§ 371 Date: Oct. 24, 2014

Related U.S. Application Data
(60) Provisional application No. 61/639,613, filed on Apr. 27, 2012.

(51) Int. Cl. G06F 19/00; G06Q 50/22; G06Q 10/10

(52) U.S. Cl. CPC G06F 19/3425; G06Q 10/10; G06Q 50/22
USPC 705/2

(57) ABSTRACT

A system of providing medical review includes a first and second devices. The first device receives a selection of a priority and at least one reviewer from a list of available reviewers (which is obtained in real time based on a priority of the message and reviewer's availability) and generates the review message including metadata of a patient, the received priority, and an identification of the received, selected reviewer. The first device receives an interpretation message based on the transmitted review message. A second device analyzes the review message in which available recommendations are identified based on the events performed and generates the interpretation message which includes a recommendation selected from the identified available recommendation options by a reviewer. The list of available reviewers is generated from the stored plurality of reviewers in real time based on the set priority and current availability of the reviewer.

### CROSS-REFERENCE TO RELATED APPLICATIONS

This application claims the benefit pursuant to 35 U.S.C. §120 of the filing data of the U.S. Provisional Application No. 61/639,613 filed on Aril 27, 2012, and titled “Referral System and Method”, the entire disclosure of which is incorporated herein by reference in its entirety.

### BACKGROUND OF THE INVENTION

1. Field

Methods, apparatuses, systems, and computer readable mediums consistent with exemplary embodiments broadly relate to providing review services, and more specifically, to providing early diagnosis by a reviewer.

2. Description of the Related Art

In related art, a person goes to a regular check up with an optometrist, a physician, and/or a dentist. During these visits, problems or uncertainties may be discovered that would require the review of a specialist. In related art, the doctor would then provide a referral to the needed specialists. The patient would then find a specialist or contact the one suggested by the primary doctor. The patient would then schedule an appointment with the specialists (which may take a long time due to busy schedules of the specialists), provide the specialist with the referrals and go in for the consultations. This process is time consuming, costly, inefficient and travel to the specialist office could be lengthy and burdensome. Accordingly, patients often may not follow up with a specialist unless there is an actual problem or injury.

For example, the person may suffer from diabetes. It is not infrequent that diabetic patients may also have eye issues. Accordingly, the doctor may suggest that the patient with diabetes see a retinal specialist to determine if actual eye problems exist. However, if the patient is not experiencing any acute eye problems, he or she may decide not to see a specialist due to the issues above and a disease may be left undiagnosed and untreated.

Nearly twenty six million Americans have diabetes and there are 79 million Americans with pre-diabetes. Approximately 45-65% of patients diagnosed with diabetes do not undergo annual eye exam. 80% of the diabetic patients eventually develop retinopathy, which is the number one cause of blindness in the US. Accordingly, there is a need to provide proactive care and treat these patients earlier to avoid blindness without the burden of the lengthy referral process or patient non-compliance.

Further, the diabetic population is estimated to double by 2050, whereas the number of retinal specialists is projected to grow by only 3% by 2050. Accordingly, the gap in the number of available specialists and number of patients will grow causing even longer delays in being seen by the specialist.

As explained above, the process by which referrals take place in today's health care system is largely paper, appointment based. The referring physician fills out a paper referral form, including any findings/notes they feel may be beneficial to the specialist. The office staff of the referring physician would then fax the referral paper work over to the specialist's office staff, with usually no confirmation that the specialist's office successfully received the referral. A referral slip containing the specialist's office information, including patient appointment phone number, which is then given to the patient. It is the responsibility of the patient to contact the specialist's office and schedule an appointment to been seen by the specialist. Once the patient calls the specialist's office and verifies a proper referral form was received by the specialist and they accept the referral, then an appointment for a specialist's office visit is scheduled. The patient would then be seen by the specialist, and the specific condition that referring physician was unsure about is verified.

Three situations now exist for the specialist.

First situation: the specific condition that the referring physician identified and issued the referral for is seen and a disease condition specific to specialist's expertise is verified. The disease is then treated by the specialist and the patient receives care for that disease. The specialist is able to then bill for services specific to their specialty. It is hoped that this case is the most prevalent.

Second situation: the condition is not verified, no specific disease state relating to the specialist's expertise is verified, and the patient is returned to the care of the referring doctor. The specialist documents the findings in the specialist's specific document, and the specialist office staff faxes the findings back to the referring physician office. At this point, the patient is then instructed to return to the referring physician, and the patient is now returned back to the referring physician. The specialist bills for a simple exam, and the patient is inconvenienced and further, adds to potentially unneeded health care costs. This second situation is obviously not productive and results in wasted time, effort, and extra expense for both the physician and the patient. The rate at which this situation occurs is, unfortunately, a function of the expertise of the referring physician, which varies with experience, as well as the ability of the specialist to set expectations and due diligence requirements on the physicians to try to ensure that this situation does not happen. There is a need in the art to try to avoid or minimize the second situation.

A third situation is that a disease is in an advanced stage, such that more aggressive treatment is now necessary, than if the disease state would have been diagnosed at an early stage. The third situation should also be avoided or minimized.

In the related art, another problem may exist in that the general doctor would not want to refer the patients to a specialist afraid of losing the patients. For example, an optometrist may see a patient for a vision test and detect a problem with the retina. The optometrist may try to remedy the problem him or herself as opposed to referring the patient to a specialist such as ophthalmologist for the fear of losing a patient. That is, the patient may form a relationship with the ophthalmologist and go for the annual visits to the ophthalmologist as opposed to the optometrist.

In today's technological age, many systems are now electronic and are available online in the financial industry, marketing industry, automotive industry, and so on. Applying existing technologies in the medical field has been challenging due to various privacy concerns and HIPAA regulations.

There is a need in the art to solve the above-noted problems and provide a more efficient specialist services.

### SUMMARY

An aspect, among other aspects, which will become apparent from reading the description herein of exemplary embodiments, is to provide a system to overcome the above-mentioned problems by facilitating specialist interpretations and reviews.

An aspect, among other aspects, is to provide an automated, electronic system in which timely electronic review is provided to the referring doctor as opposed to a direct interaction with the patient.

An aspect, among other aspects, is to provide seamless and consistent, perhaps even constant, interaction between a primary care doctor and a specialist.

An aspect, among other aspects, is to minimize the occurrence of the second situation described above by performing a remote pre-referral review by the specialist to determine if an appointment with the specialist is necessary.

Illustrative, non-limiting embodiments may overcome the above-noted disadvantages and problems in the prior art, and also may have been developed to provide solutions to other disadvantages and problems that were not described above. However, a method, an apparatus, a system, and a computer readable medium that operates according to the teachings of the present disclosure is not necessarily required to overcome any of the particular problems or disadvantages described above. It is understood that one or more exemplary embodiment is not required to overcome the disadvantages described above, and may not overcome any of the problems described above.

According to an exemplary embodiment, a method, a system, an apparatus including a memory and a processor and a non-transitory computer readable medium for providing medical review are provided.

According to an aspect of an exemplary embodiment, a method includes: selecting by a user at least one reviewer from a list of available reviewers; setting a priority for a reply; generating, by a computer, a review message comprising metadata of a patient, obtained by a plurality of events performed on a part of the patient, the set priority, and an identification of the selected reviewer; transmitting the generated review message over a guaranteed network; and receiving an interpretation message over the guaranteed network based on the transmitted review message. The list of available reviewers is generated in real time based on the set priority and the current availability of the reviewer.

According to yet another exemplary embodiment, a method of providing medical review includes: receiving a review message comprising metadata of a patient containing a plurality of events performed on a part of the patient, a priority, and an identification of at least one reviewer, analyzing, by a computer, the review message in which available recommendations are identified based on the events performed, generating an interpretation message which comprises a recommendation selected from the identified available recommendation options by a reviewer, and transmitting the generated interpretation message over a network.

According to yet another aspect of an exemplary embodiment, the apparatus of generating a review message includes: a memory storing a plurality of reviewers, a communication interface configured to receive a selection of at least one reviewer from a list of available reviewers and a priority for a reply selected by a user, and a processor configured to generate a review message comprising metadata of a patient, obtained by a plurality of events performed on a part of the patient, the received priority, and an identification of the received, selected reviewer. The communication interface transmits the generated review message over a guaranteed network and receives an interpretation message over the guaranteed network based on the transmitted review message. The list of available reviewers is generated from the stored plurality of reviewers in real time based on the set priority and current availability of the reviewer.

According to yet another aspect of an exemplary embodiment, an apparatus of providing medical review includes a communication interface configured to receive a review message including metadata of a patient containing a plurality of events performed on a part of the patient, a priority, and an identification of at least one reviewer, a processor configured to analyze the review message in which available recommendations are identified based on the events performed and configured to generate an interpretation message which comprises a recommendation selected from the identified available recommendation options by a reviewer. The communication interface may transmit the generated interpretation message over a network.

According to yet another aspect of an exemplary embodiment, the system of providing medical review includes a first device for generating a medical review message and a second device. The first device includes: a first communication interface configured to receive a selection of at least one reviewer from a list of available reviewers and a priority for a reply selected by a user, configured to transmit a review message over a guaranteed network and receive an interpretation message over the guaranteed network based on the transmitted review message, and a first processor configured to generate the review message comprising metadata of a patient, obtained by a plurality of events performed on a part of the patient, the received priority, and an identification of the received, selected reviewer. The second device includes a second communication interface configured to receive the review message from the first device and transmit an interpretation message over the guaranteed message in response to the review message and a second processor configured to analyze the review message in which available recommendations are identified based on the events performed and configured to generate the interpretation message which comprises a recommendation selected from the identified available recommendation options by a reviewer. The list of available reviewers may be generated from the stored plurality of reviewers in real time based on the set priority and current availability of the reviewer.

### BRIEF DESCRIPTION OF THE DRAWINGS

The accompanying drawings, which are incorporated in and constitute a part of this specification exemplify the exemplary embodiments and, together with the description, serve to explain and illustrate exemplary embodiments. Specifically:

FIG. 1 is a block diagram illustrating a system for providing medical review according to an exemplary embodiment.

FIG. 2 is a flow chart illustrating a method of obtaining a review using the PRN system according to an exemplary embodiment.

FIG. 3 is a block diagram illustrating components of a review system according to an exemplary embodiment.

FIG. 4 is a block diagram illustrating layers of a review system according to an exemplary embodiment.

FIG. 5 is a view illustrating an eye review system according to an exemplary embodiment.

FIG. 6 is a flow chart illustrating a method of generating a new review message according to an exemplary embodiment.

FIGS. 7A-7D are views illustrating exemplary patient information input screens for generating a new referral message according to an exemplary embodiment.

FIG. 8 is a view illustrating setting of a priority for a review message according to an exemplary embodiment.

FIG. 9 is a flow chart illustrating a method of generating a list of available specialists according to an exemplary embodiment.

FIG. 10 is a view illustrating a method of selecting a specialist according to an exemplary embodiment.

FIGS. 11A-11D are views illustrating user interfaces for inputting referral related information according to an exemplary embodiment.

FIG. 12 is a view illustrating a user interface for the generated review messages in a PRN system according to an exemplary embodiment.

FIGS. 13A and B are views illustrating user interfaces for managing review messages according to an exemplary embodiment.

FIG. 14 is a view illustrating a user interface for setting the status of the specialist according to an exemplary embodiment.

FIG. 15 is a flow chart illustrating a method of interpreting a review message according to an exemplary embodiment.

FIG. 16 is a view illustrating a user interface for a specialist to analyze the review message according to an exemplary embodiment.

FIG. 17 is a flow chart illustrating a method of obtaining possible diagnosis according to an exemplary embodiment.

FIGS. 18A-18D are views illustrating user interfaces for selecting at least one recommendation according to an exemplary embodiment.

FIG. 19 is a flow chart illustrating a method of generating an interpretation letter according to an exemplary embodiment.

FIG. 20 is a view illustrating a generated interpretation letter according to an exemplary embodiment.

### DETAILED DESCRIPTION OF EXEMPLARY EMBODIMENTS

Exemplary embodiments will now be described in detail with reference to the accompanying drawings. Exemplary embodiments may be embodied in many different forms and should not be construed as being limited to the illustrative exemplary embodiments set forth herein. Rather, the exemplary embodiments are provided so that this disclosure will be thorough and complete, and will fully convey the illustrative concept to those skilled in the art. Also, well-known functions or constructions may be omitted to provide a clear and concise description of exemplary embodiments. The claims and their equivalents should be consulted to ascertain the true scope of an inventive concept.

In an exemplary embodiment, a new electronic system is provided which allows for a remote review in real time. In an exemplary embodiment, the referring user such as the primary care physician may request the services of the specialists using an online system. An exemplary embodiment provides a HIPAA compliant cloud based diagnostic referral network, in which a referrer may obtain specialist expertise in real-time and unnecessary appointments to the specialist may be avoided. In an exemplary embodiment, the pre-referral online review may save both time and money by determining if an actual referral is in fact necessary. The primary doctor can obtain an expert's advice without the fear of losing a patient and without subjecting the patient to the lengthy referral process unless it is really necessary (avoid the second situation described in the related art).

In an exemplary embodiment, early review will further avoid advancements of the disease and allow for earlier detection. Thereby avoiding the third situation.

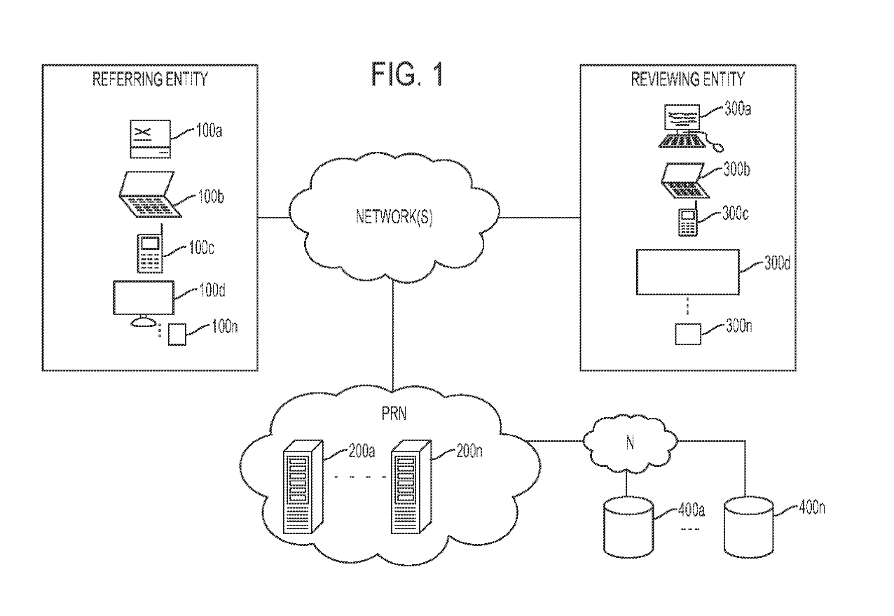

FIG. 1 is a block diagram illustrating a system for providing medical review according to an exemplary embodiment.

The exemplary system includes one or more user devices 100a-100n. The user devices 100a-100n may be used by the referring entity such as a primary care physician or other medical personnel that require the review by a specialist. One of ordinary skill in the medical arts would appreciate that the referring entity issues a pre-referral check based on the provided information. The pre-referral check may be used to determine if an actual referral to the specialist is required, as detailed below. The specialist interprets the referring entity's finding to help the referring entity determine if a referral is needed. In an exemplary embodiment, the specialists review the findings of the referring entity and determine if an appointment with the specialist is necessary for the medical diagnosis. In an exemplary embodiment, the specialist confirms or rejects the findings of the referring entity.

The referring entity generates a review message (which will be described in further detail below) using a user device such as the user devices 100a-100n. For example, a user device may be a computer such as a personal computer 100a, a laptop, a tablet, and/or a notebook 100b, a telephone 100c such as a LAN line telephone, a mobile terminal such as a smart phone, and an IPTV 100d e.g., a TV with a set-top-box (STB). The user devices may have peripheral devices such as a display (e.g., a cathode ray tube (CRT), plasma display, or a liquid crystal display (LCD), a mouse, a keyboard, a remote control, a data source, and so on.

The exemplary system further includes analogous devices 300a . . . 300n. These devices are analogous to the user devices 100a-100n described above and as such, detailed description will be omitted. These devices 300a . . . 300n are provided for the reviewing entity i.e., specialists. The reviewing entity analyzes the review message and based on the review message provide their review/interpretation/expertise, described in greater detail below.

The exemplary medical review system may further include one or more backend servers 200a-200n that may be distributed in a cloud environment. The backend servers 200a-200n may interact with the client devices 100a-100n and 300a-300n to generate the review message, to generate the interpretation message, and manage the process flow of the review. The backend servers 200a-200n may form a physician referral network (PRN) system according to an exemplary embodiment.

The exemplary user devices 100a-100n. 300a-300n, and the exemplary servers 200a-20n may include a data bus or other communication mechanism for communicating information across and among various parts of the device/server and communication interfaces for communicating information outside the device/server, and a processor coupled with bus for processing information and performing other computational and control tasks, a volatile storage, such as a random access memory (RAM) or other dynamic storage device, coupled to the bus for storing various information as well as instructions to be executed by processor and a nonvolatile storage such as a read only memory (ROM or EPROM) or other static storage devices coupled to the bus for storing instructions for processor. A persistent storage device, such as a magnetic disk, optical disk, or solid-state flash memory device is provided and coupled to the bus for storing information and instructions. Each of the server 200a-200n may include a processor, an input/output unit, and a memory, and may optionally also include a display.

Separate databases (data source) 400a-400n may be provided for storing information related to referring entity, specialists, corresponding provider organizations, review messages, diagnostic messages, and so on. These databases 400a-400n may include one or more memories and one or more physical interfaces to provide information via a network N, which may be wired or wireless network.

The user devices 100A-100n and 300a-300n may be connected to the PRN system comprising servers 200a-20n and to each other via various different networks, which may include a wired or wireless network (optic, cables, etc.), a data network such as an Internet, a Public Switched Telephone Network, and so on. The user devices 100A-100n and 300a-300n may have a communication interface, such as network interface card. The communication interface provides a two-way data communication coupling to a network link that is connected to a local network. For example, communication interface may be an integrated services digital network (ISDN) card or a modem to provide a data communication connection to a corresponding type of telephone line. As another example, communication interface may be a local area network interface card (LAN NIC) to provide a data communication connection to a compatible LAN. Wireless links such as 802.11a, 802.11b, 802.11g and Bluetooth may also be used.

For example, the user terminal 100a and 300a are PCs that connect to the network to communicate with the servers 200a-200n or other user devices using various types of networks such as LAN connecting to Internet, Public Switched Telephone Network (PSTN), and so on. The user terminals 100b and 300b are notebooks, which connect to the network using a network which may include wireless communication such as WIFI, Bluetooth, or via wired communication such a cable and a modem that connects the notebook to the Internet. The user terminals 100c and 300c are smart phones that communicate via a base station using a cellular network such as GSM, CDMA, and so on to connect with each other or the servers 200a-200n. The user terminals 100d and 300d may be televisions such as an IPTV, which connect to the network using a cable network and/or data network such as the Internet to communicate with other user terminals or the backend servers 200a-200n.

The user devices 100a-100n and 300a-300n may connect to the network(s) through gateway/firewall where the network may be a wide-area or global network.

The physician referral network (PRN) system may be embodied as a software application according to an exemplary embodiment and may be stored on various computer-readable mediums. The term “computer-readable medium” as used herein refers to any medium that participates in the processes described above. The computer readable medium may be a computer readable signal medium or a computer readable storage medium.

A computer readable storage medium may be, for example, but not limited to, an electronic, optical, magnetic, electromagnetic, infrared, or semiconductor system, apparatus, or device, or any suitable combination of the foregoing. More specific examples (a non-exhaustive list) of the computer readable storage medium may include the following: a portable computer diskette such as a floppy disk or a flexible disk, magnetic medium, a hard disk, ROM, EPROM (flash), RAM or any other memory chip or cartridge, an optical fiber, a portable compact disc read-only memory (CD-ROM), any other optical medium, a tape, punchcards, papertape, an integrated circuit, any other physical medium with patterns of holes, or any other medium usable by a computer now known or heareinafter developed. A computer readable storage medium may be any tangible, non-transitory medium that can contain, or store a program for use by or in connection with an instruction execution system, apparatus, or device or data that is used in the program or the instructions execution system.

A computer readable signal medium may include a propagated data signal with computer readable program code embodied therein, for example, in a base band or as part of a carrier wave. Program code embodied on a computer readable signal medium may be transmitted using any appropriate medium, including but not limited to wireless, wire line, optical fiber cable, RF, etc. or any suitable combination of the foregoing.

Although the enabling software might be “written on” a diskette, “stored in” an integrated circuit, or “carried over” a communications circuit, it will be appreciated that, for the purposes of this application, the computer readable medium will be referred to as “including” the software. Thus, the term “including” is intended to encompass the above and all equivalent ways in which software is associated with a computer usable medium.

An illustrative, non-limiting embodiment is the PRN system which provides review/diagnosis by a reviewing entity in response to a request from a referring entity. The PRN system may be embodied as a software application and can be delivered to the user via a web-based graphical user interface. The PRN software application can also be deployed over a dedicated computer network (e.g., a LAN or a WAN), or via a stand-alone computer system for a particular company, such as an intranet installation, or by some other means. For simplicity and ease of discussion, various illustrative, non-limiting embodiments will be described with reference to an Internet/world wide web-based system, with the understanding that networks or communications systems similar to, but not identical with the Internet, may of course be used.

On a practical level, the software of the PRN application enables the computer system to perform the operations described in further detail below and may be supplied on any one of a variety of media. Furthermore, the actual implementation of the approach and operations of exemplary embodiments are actually statements written in a programming language. Such programming language statements, when executed by a computer, cause the computer to act in accordance with the particular content of the statements. Furthermore, the software that enables a computer system to act in accordance with an exemplary embodiment may be provided in any number of forms including, but not limited to, original source code, assembly code, object code, machine language, compressed or encrypted versions of the foregoing, and any and all equivalents.

The PRN application may be embodied as online software accessible through the web and/or mobile device(s) that allows the referring entity to generate a review message and allows the review entity to provide the review/interpretation. In an exemplary embodiment, the review entity provides its expertise with respect to the findings of the referring entity. In an exemplary embodiment, specialist services may be provided without having the patient go through the lengthy referral process, without the physician or the referring entity fearing of losing a patient, and allowing for early detection of diseases where the patient would not have otherwise obtained an expertise of the specialist. The PRN application is secure, real-time, and HIPAA compliant.

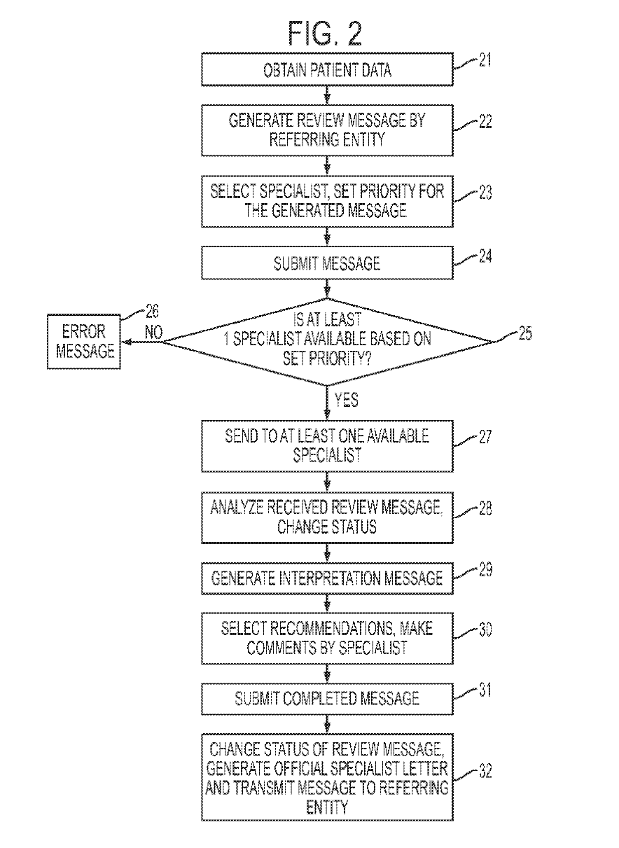

FIG. 2 is a flow chart illustrating a method of obtaining a review using the PRN system according to an exemplary embodiment.

In operation 21, the referring entity obtains patient data. For example, obtaining patient data may include images, observations, test results, and so on, which may be relevant to the condition to be reviewed. In operation 22, the referring entity generates a review message, which would include specific medical metadata needed for billing purposes for the reviewer. The review message is described in greater detail below. The referring entity selects a reviewer (e.g., specialist) and sets a priority to the message in operation 23 (both of these will be described in greater detail below). By way of an example, the referring entity may designate a particular specialist or two or may designate one or more practice groups for the specialist services. The referring entity then submits the review message, in operation 24.

The review system analyzes the priority of the message to determine if at least one of the selected specialists is available to handle the generated message based on the priority status set by the referring entity, in operation 25. If no specialist can provide interpretation and his or her analysis of the review message based on the priority specified by the referring entity, an error message is generated and the generated message is returned to the referring physician for further edits, in operation 26. The error message may be displayed on the screen or placed in the referring physician's inbox, for example, it may say “sorry, no specialists are available to review the data in the specified period of time.” The output messages described above are provided by way of an example and not by way of a limitation. In other exemplary embodiments, the message may be output in a form of a video, an SMS, a fax, a voice message, and so on. The contents of the messages may also vary.

If at least one specialist is available (Yes) in operation 25, the message is sent to the at least one available specialist and is placed in their inbox (by way of an example) in operation 27. This is provided by way of an example only and not by way of a limitation. In an exemplary embodiment, the at least one available specialist may be notified via an automatic call, fax, voice message, SMS, video, a page, and so on. The specialist(s) is notified that a new review message has arrived and is awaiting their review. Different methods of notifying may also be provided based on the priority of the message. For example, an urgent priority message may require a page to at least one available specialist, whereas a normal priority message may simply be placed in the specialist's inbox. The review message is set to the “submitted” status.

Once the specialist decides to review the message, the status of the message is changed to “assigned”, in operation 28. This way if there are other available specialists, they know, based on the status of the message, that it is already being handled and duplicative efforts are prevented. Further, the referring entity also knows that the message is currently being analyzed based on its status.

The specialist analyzes data provided in the review message and generates an interpretation message, in operation 29. The interpretation message is automatically generated based on data in the review message. In an exemplary embodiment, fields and available actions for the specialist are automatically generated based on test types and/or other information specified in the review message. Accordingly, the specialist selects recommendations, makes comments and provide their findings/interpretation i.e., fill in the generated interpretation message, in operation 30. The specialist may then submit the filled in interpretation message, in operation 31. When the interpretation message is submitted, the status of the review message changes to “reviewed” in operation 32, for example. In addition, the review system generates a letter with the specialist's letter head and electronic signature, which includes at least some of the information filled in by the specialists, in operation 32. The letter is attached or made part of the interpretation message and is provided/transmitted to the referring entity, in operation 32.

Accordingly, in an exemplary embodiment, a specialist diagnosis is obtained without the referring entity fearing to lose a patient and without a patient having to go through the lengthy referral process described in the related art unless a condition is found during the pre-referral process. In an exemplary embodiment, the situation two described in the related art is handled without wasting patient's time and resources of the entities involved. Further, early detection may be made possible by obtaining opinion of the specialist with respect to the findings of the referring entity.

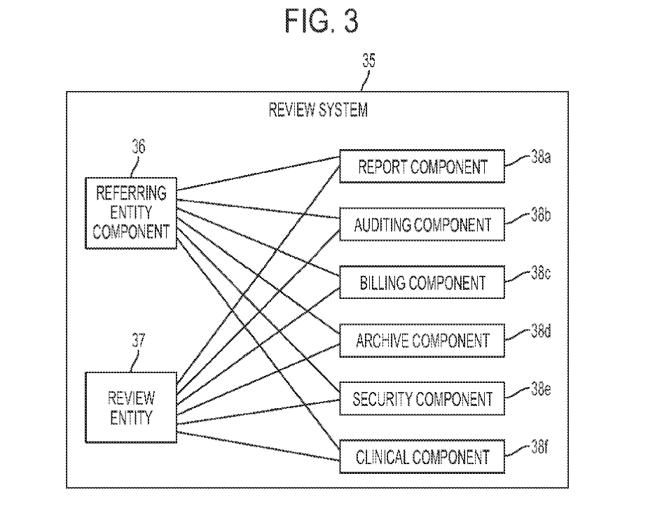

FIG. 3 is a block diagram illustrating components of a review system according to an exemplary embodiment.

In an exemplary embodiment, a review system 35 is an internet, cloud based system that allow for a creation of referring entities and review entities referral pool, in which the referral relationships between the specialists (review entities) and their referral entities are defined and stored. Further, in an exemplary embodiment, the review system allows for a creation of a pre-referral consultation services, which contains images and other metric, audio/video data taken by various medical equipment at the referring entities' office, along with any pre-referral notes. Additionally, the initial request may contain pre-filled patient information and a basic data set e.g., specific diagnosis codes indicating tests performed, diagnosis provided, and so on. A single review message may then be generated and provided to the review entity for interpretation/review.

According to an exemplary embodiment, the users (referring entities and review entities) may use a workstation and/or a smart phone that allow for the easy creation, review and display of the interpretation results (review messages and interpretation messages).

According to an exemplary embodiment, the users are notified of the arrival of a new message (review messages and interpretation messages). Alarms, reminders, and so on may be provided to help alert the user to the incoming new request and returned interpretation/findings.

In an exemplary embodiment, a referring entity component 36 and a review entity component 37 are provided and are configured to handle the review messages and the interpretation messages, as described in further detail below.

According to an exemplary embodiment, a review system allows the users to review their to-date activities. This activity may be handled by a report component 38a. This report component 38a is configured to allow the users to track metrics-like number of referral requests and/or diagnosis provided by specific user, by status, based on priority, and so on. Various filters and color coding techniques are provided in an exemplary embodiment to review the to-date referral activities.

According to an exemplary embodiment, a review system may also include an auditing component 38b. The auditing component 34 tracks all activities by each user, ensuring service level agreements for review are met. A billing component 38c tracks the transactions and applies billing rules to create monthly invoices for both types of users. There should also be a capability to set up automatic bill pay with credit card, following online billing protocols.

According to an exemplary embodiment, a review system may further include an archive component 38d. The archive component 38d allow for the export of data for the long term storage in the users' ancillary computer system. The archived documents include the pre-referral notes and information of the review message, result report and information of the interpretation message, as well as any images (in lossless jpeg compression format) embedded in the document and all official letters generated in the process.

In an exemplary embodiment, the various components 38a-38d communicate with the respective entity component 36 and/or 37 to provide the required information. To facilitate communication between various components, a management component (not shown) may be provided to coordinate functions of various components.

In an exemplary embodiment, the review system may further include a security component 38e and a clinical component 38f. The security component 38e will manage authentication information with respect to the referring entity and the specialist. The security component 38e may communicate with the respective entity component 36 and/or 37 to ensure secure access to the respective user accounts. The security component 38e may manage user accounts and passwords, for example. Further, the security component 38e may manage encryption and decryption of various fields in the review message and the interpretation message e.g., patient information. In an exemplary embodiment, the review system may further include a clinical component 38f. The clinical component will manage all clinical/medical informatics of the review system. The clinical component system will communicate the respective entity component 36 and/or 37 to ensure proper clinical representation between findings, recommendations and interpretation is maintained.

The exemplary components described above may be software per se or may include a combination of hardware and software such as FPGA and ASIC.

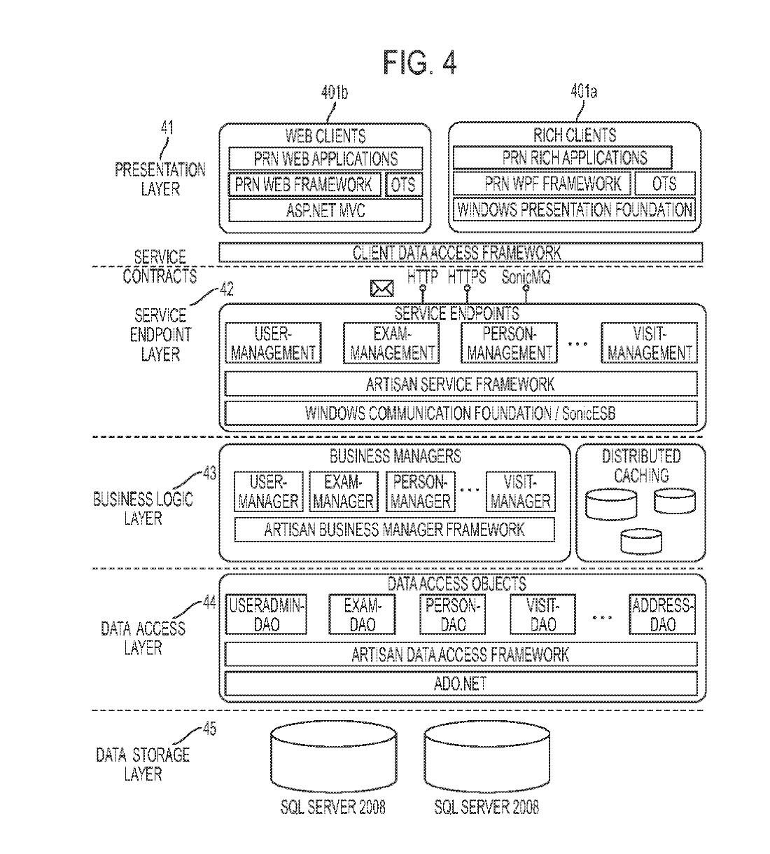

FIG. 4 is a block diagram illustrating layers of a review system according to an exemplary embodiment. As illustrated in FIG. 4, the review system includes a presentation layer 41, a service endpoint layer 42, a business logic layer 43, a data access layer 44, and a data storage layer 45.

The presentation layer 41 may include a rich client 401a. The rich client 401a includes the necessary components on the user device (such as the devices 100a-100n and 300a-300n). Although in an exemplary embodiment, the PRN application running on a client may be automatically updated via internet, the exemplary rich client 401a is a standalone application installed on the user device. The presentation layer may also include a thin client 401b. A thin client 401b is a web based client, where the workload is handled by the backend servers and the thin client is equipped to generate requests to the servers and output results.

The service endpoint layer 42 may include HTTP, HTTPS, and/or Queuing service endpoints. These endpoints, in an exemplary embodiment, may allow the user devices (such as the devices 100a-100n and 300a-300n) to request the processing of certain business functions as needed and required by the PRN application.

The business logic layer 43 may include business managers, User Manager, Exam Manager, Person Manager, and/or Visit Manager, as well as a Distributed Caching Manager according to an exemplary embodiment. In an exemplary embodiment, these business managers act on behalf of the service endpoints as described above with reference to the service endpoint layer 42 to process certain business functions as required by the PRN application.

The data access layer 55 may include certain data access objects, like user administration, exam person, visit, and address according to an exemplary embodiment. In an exemplary embodiment, these data access objects act on behalf of the business managers to process certain business functions as required by the PRN application.

The data storage layer 45 may include certain database management servers according to an exemplary embodiment. In one exemplary embodiment, these database management servers act on behalf of the data access objects to persistent certain business functions to non-volatile storage, as required by the PRN application.

An exemplary embodiment of an ophthalmology review system is explained in greater detail below. One of ordinary skill in the art would readily appreciate that the described ophthalmology review system is provided by way of an example only. Other review systems e.g., in the field of dermatology, cardiology, mammography, and so on are within the scope of the present disclosure. One of ordinary skill in the art would readily appreciate that the above-noted system may be applied to specialists in these areas as well. For example, a referring entity may be a primary care physician and the review entity may be a dermatologist. This is provided by way of an exemplary only.

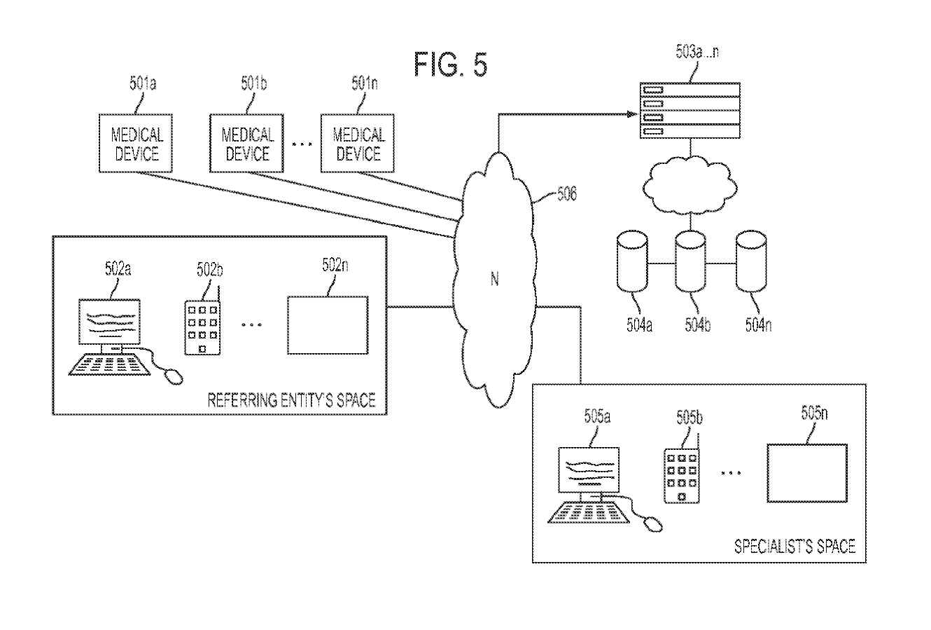

According to an exemplary embodiment, the ophthalmology review system further includes medical equipment such as fundus image capturing devices, as detailed below. FIG. 5 is a view illustrating an eye review system according to an exemplary embodiment.

In an exemplary embodiment shown in FIG. 5, additional medical devices 501a . . . 501n are provided. These medical devices 501a . . . 501n may be provided in a referring entity's office. In yet another exemplary embodiment, these, some, or none of these medical devices may be remote from the referring entity's office. By way of an example, the medical device 501a may be a fundus image capturing device such as Nidek AFC-330. The medical device 501a outputs medical images of the eye fundus. The medical device 501b may be an eye pressure measuring device e.g. a tonometer. The medical device 501b outputs metric values such as intraocular pressure in mmHG values for example. The results gathered by the medical devices 501a . . . 501n may be processed by the back end servers 503a . . . 503n and stored in distributed databases 504a . . . 504n. In an exemplary embodiment, the back end servers 503a . . . 503n may analyze output from the medical devices 501a . . . 501n, convert them to a standardized format and store the converted values as well as the original values. For example, images captured by various different types of fundus image capturing devices may be converted to jpeg format. Metric values may be converted to one standard and stored as XX mmHG, for example.

In an exemplary embodiment, another medical device may be a handheld video infrared indirect ophthalmoscope, which connects and transmits images and patient information directly from the device to one or more backend servers 503a . . . 503n.

In the eye care space, the vast majority of referrals come from optometrists to vitreoretinal surgeons. During the course of a normal eye examination, the optometrist may discover an eye condition during the eye examination, or possibly from a family history or patient complaint, that warrants a Vitreoretinal (VR) specialist consult. As VR conditions are complex, involving structures measured in microns, and require special training and medical devices to treat and diagnose, most optometrists refer to the VR physician any patient that presents even remotely signs of abnormality. This can result in the VR specialist receiving a large volume of patients that require little or no specialist care, leading to a less productive practice, and annoyance and frustration on the part of the patient. It also can lead to less trust or confidence in the capabilities and expertise of their referring optometrist.

To a lesser degree, general ophthalmologists, like cataract or LASIK surgeons, also refer their patients to the VR specialist, for any patient presenting with what appears to be, thru early diagnosis, a VR disease. This source of referral is less of a chance to have no VR disease present, and also represents a much smaller percentage of patients seen by the VR specialist. Further, primary care doctors may require a VR specialist review and various medical institutions such as hospitals and clinics may require a review by a VR specialist.

According to an exemplary embodiment, an ophthalmology review system provides a review service. A review is a mechanism by which multiple (usually 2) physicians/providers can review a case for a specific patient. Typically, a referring physician such as an optometrist encounters a situation in which they are unsure of a diagnosis for a condition in which they are not familiar, nor trained or certified to diagnose or one in which they are sure of the diagnosis, but are not able to provide the patient care for that condition. The referring entity then wishes to consult with a specialist (a reviewing entity) who has expertise in the diagnosis and treatment of the specific disease and with whom they have a referral relationship. This specialist would then accept the review and determine if an actual referral is needed. If needed a referral of the patient to the specialist would be initiated and the specialist would do additional procedures to determine a diagnosis. The specialist, upon accepting the referral, assumes ownership of patient care for this specific disease state, and responsibility for outcomes of prescribed remedies. In an exemplary embodiment, the interpretation message provided by the specialist confirms or rejects the findings of the referring entity. Accordingly, in an exemplary embodiment, the patient remains in the case of the referring entity.

The specialist may provide the interpretation message, which includes the specialist's findings based on the information in the review message and possible treatment recommendations to the referring entity using one of the devices 505a . . . 505n. The referring entity, the specialist, the medical equipment, and the backend servers 503a . . . 503n may communicate with each other using network 506, which may include a number of networks.

In an exemplary ophthalmology review system, the situation 2 where full referral is not necessary is to be determined. In an exemplary embodiment, the specialist performs a review of the findings by the referring entity, which is the process by which a specialist determines, by reviewing images, patient demographics and/or patient partial medical histories, if a referral to a specific is needed to diagnose patient condition. In other words, in an exemplary embodiment, the referring entity requests a “pre-review” of available data to determine if an appointment/referral to the specialist is needed. Accordingly, a situation in which the patient is referred to a specialist when the patient does not have a condition is further minimized. As a result, time and efforts of the patient and the doctors (referring and specialist) are saved. Further, financial costs are also minimized by avoiding unnecessary referrals and visits to the specialists.

Reviews—Referring Entity

An exemplary embodiment of the referring entity generating a review according to an exemplary embodiment will now be described in detail. One of ordinary skill in the art would readily appreciate that this is provided by way of an example only and not by way of a limitation.

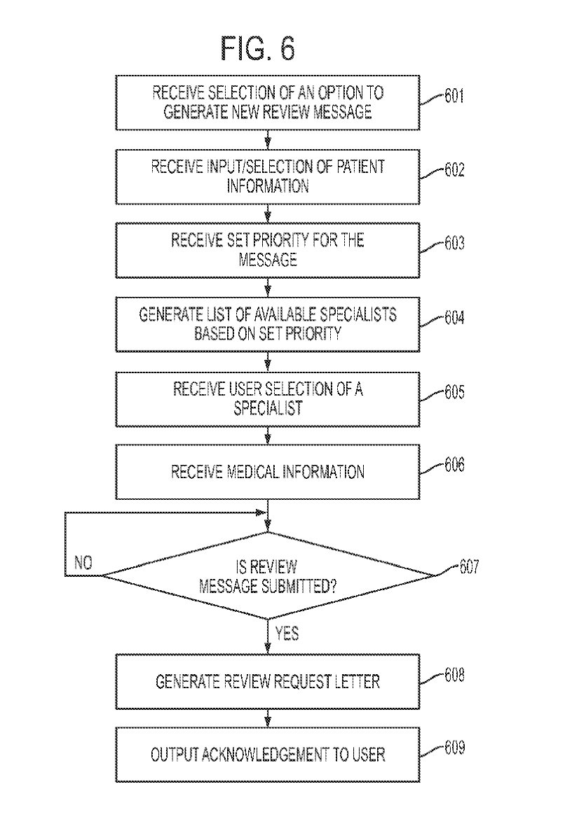

FIG. 6 is a flow chart illustrating a method of generating a new review message according to an exemplary embodiment.

In operation 601, the user, which may be a primary care physician or a staff in their office, selects to generate a new review message. To generate a new review, the user may first select an icon “G” for example. In operation 602, the user may then need to select a patient already present in the system or input information for a new patient. For example, once the user starts to type in the first name of the patient, a drop down box may be provided with suggestions. The suggestions are from existing patients of the primary care physician that are already stored in the system. If the primary care physician selects one of the suggestions, the remaining section for the patient is auto-populated and the primary care physician would simply need to confirm information by clicking “ok” or “confirm” button, for example.

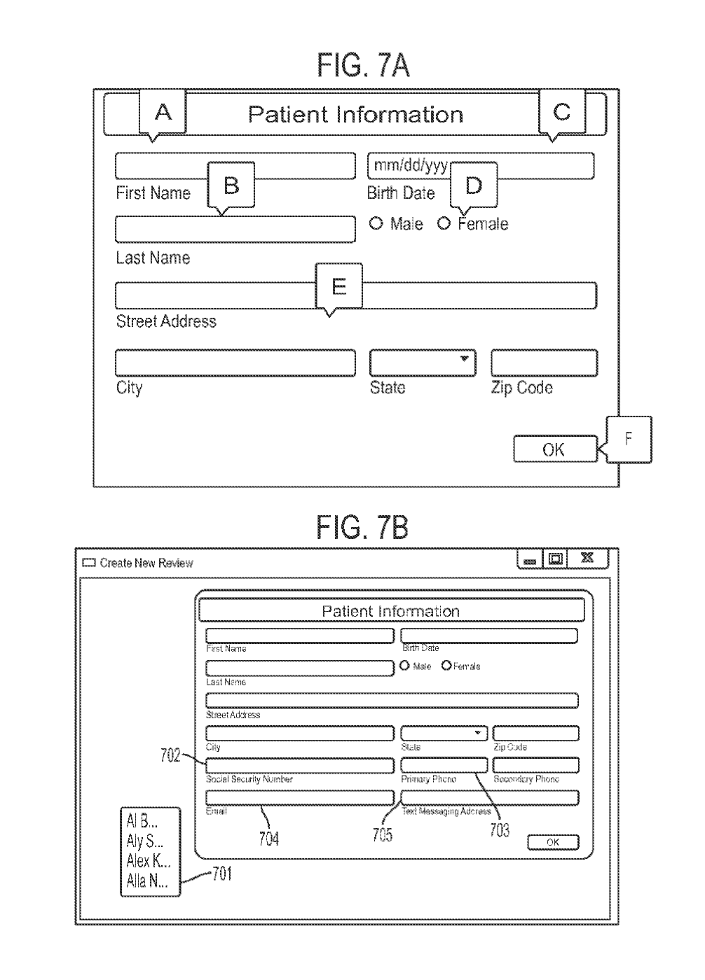

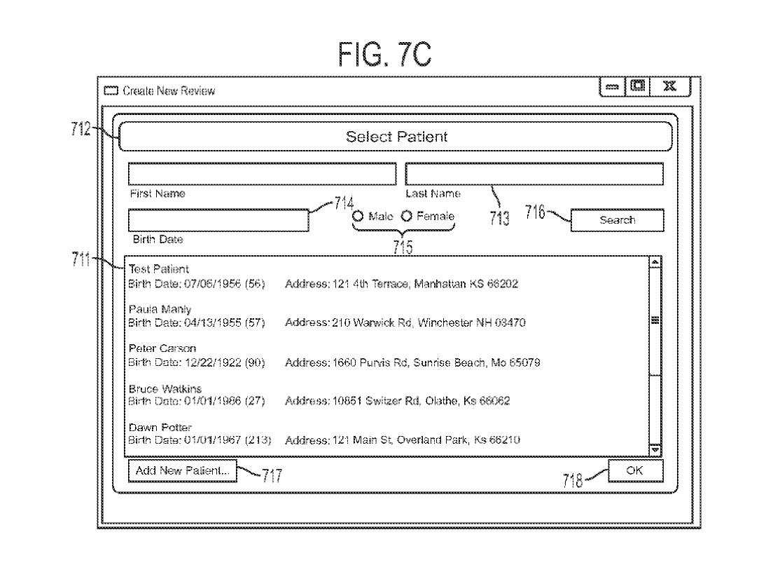

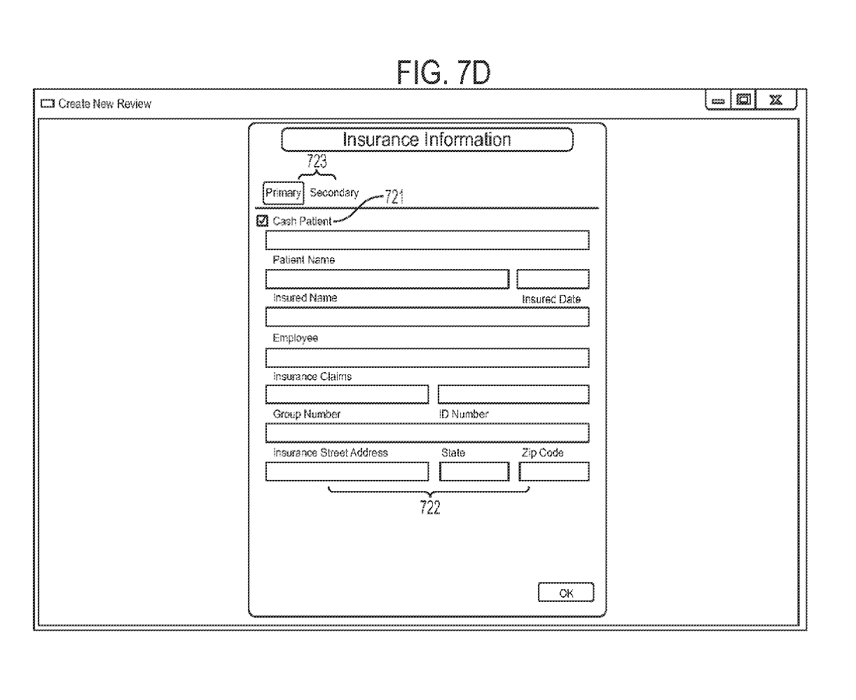

FIGS. 7A-7D are views illustrating exemplary patient information input screens for generating a new referral message according to an exemplary embodiment. In FIG. 7A a user interface, which shows various patient information being input by the user. The user interface may be a pop-up box or maybe a tab for generating a review. For example, the user may input patient first name (field A), patient last name (field B), patient birth date (field C), male/female (field D), address (field E). Once the information is input, the user may click “ok” or “submit” (field F) to go onto the next screen or to exit to the main screen in generating a review.

In FIG. 7B, a drop down box (field 701) is provided with possible suggestions in patient's names. Additional information such as a social security number, (field 702), a phone number (field 703), an email (field 704) and a text messaging address/fax (field 705) may be provided.

In FIG. 7C, the user may choose to select an existing patient by either scrolling through a list 711 or inputting a variation of a first name 712, last name 713, a birth date 714, and sex 715 and submitting for a search 716. In response to selecting element 716, a list may be provided specific to the input search criteria in field 711. Further the user may select to add new patient 717. Once the patient is selected/found, the user may select to proceed with generating a new review message by clicking “submit” or “ok” 718 for example.

Addition, as shown in FIG. 7D, the user may further input insurance information. The user may check that a patient is paying out of pocket (field 721). The user may input insurance name, group number, group ID, name of patient as it appears on the card, and insurance address (field 722), and select as primary or secondary insurance (field 723). It is possible that additional fields are provided to select that the secondary insurance is the same as primary insurance and whether to include the primary or secondary or both in the newly generated review message.

These fields are provided by way of an example only. Many other fields for the patient information are within the scope of the present disclosure as will be readily apparent to one of ordinary skill in the art.

Referring back to FIG. 6, once the patient information is selected or input, in operation 603, the user may set a priority of the review. Since availability of the specialists may depend on the input priority of the message, the PRN system may recommend that the user first sets a priority to the message. In an exemplary embodiment, the option to select a specialist may be unavailable until the user sets a priority of the review. In yet another exemplary embodiment, a specialist may immediately be suggested based on the priority set by the user.

In another exemplary embodiment, the user first selects a specialist and when the user tries to set a priority inconsistent with the selected specialist, an error message may be output. In yet another exemplary embodiment, the user may set priority and/or select specialist in any order. However, if the specialist is not available for the priority set by the user, an error message is output once the user tries to submit the review message.

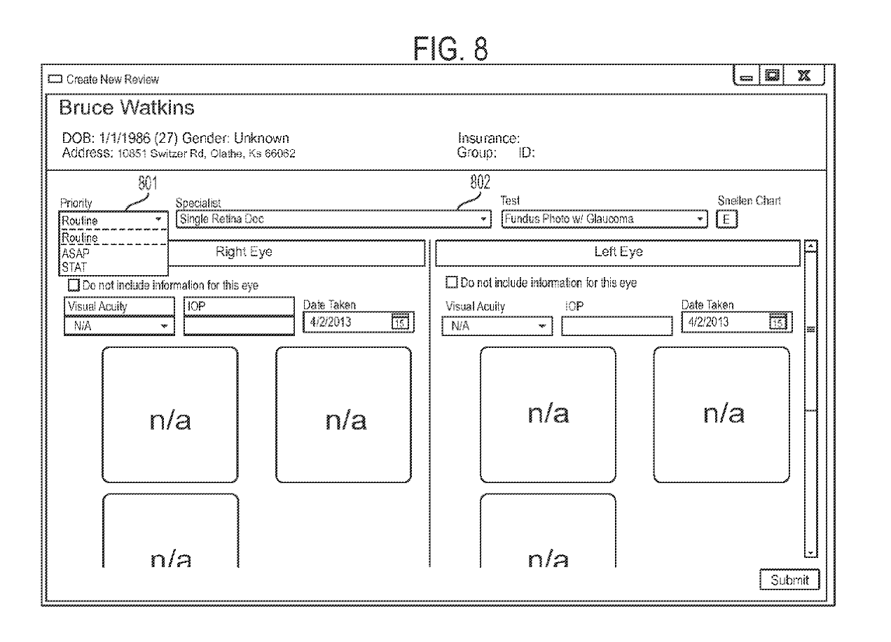

FIG. 8 is a view illustrating setting of a priority for a review message according to an exemplary embodiment. As shown in FIG. 8, the priority may be set in field 801 by selecting from a drop down menu. For example, the priority may include routine—within a day for example, ASAP to be reviewed within six hours, and STAT to be reviewed within an hour, for example. The specific values provided are by way of an example only and may be preset by the user or preconfigured by the system based on numerous factors such as the field of use (e.g. type of test), and so on. In an exemplary embodiment, the setting of priority 801 may influence available options in field 802.

In an exemplary embodiment, a list of specialists associated with the referring entity is stored in a system. By way of an example, the referring entity may add new specialists to his or her network. The PRN system may also suggest specialists that are to be added to the referring entity's network. In an exemplary embodiment, however, the list of available specialists depends on the network of the referring entity. Each referring entity may have its own list of specialists or may select to have the PRN system suggest specialists for the area.

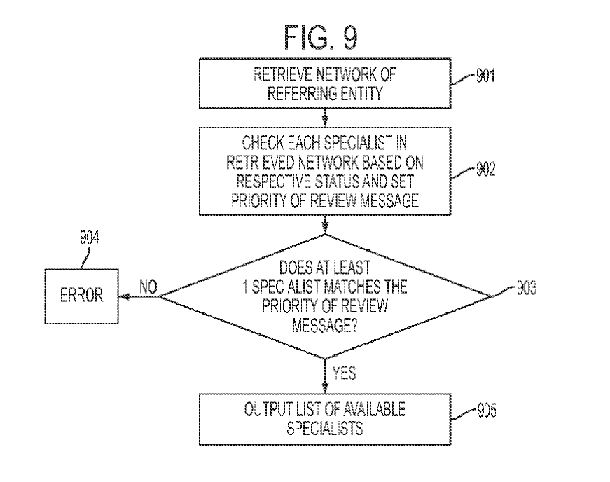

In an exemplary embodiment, referring back to FIG. 6, in operation 604, the list of available specialists is generated based on the set priority. FIG. 9 is a flow chart illustrating a method of generating a list of available specialists according to an exemplary embodiment.

In FIG. 9, in operation 901, the network of specialists of the referring entity is retrieved. It is noted that the network may include specialists from different fields. Accordingly, the referring entity would then first select a field for the network. Exemplary embodiment relates to ophthalmology review system. Accordingly, in an exemplary embodiment, it is assumed that the specialist network is all in the field of retina specialists.

In operation 902, it is checked whether each specialist in the retrieved network is able to meet the priority of the review message specified by the user. In an exemplary embodiment, the status of the respective specialist is checked against the priority of the review message. The status of the specialists will be explained in greater detail below. By way of a brief explanation, however, each specialist may set his or her status e.g., currently available, regular, or not available. By way of another example, once a specialist logs in, his status may change to “currently available” automatically by the system. If the specialist logs in daily, his status may be set by default to “regular”. If the specialist is leaving for vacation, he may set his status to “not available”. In yet another exemplary embodiment, the PRN system may automatically set the specialist's status to “not available” if inactivity is detected for a few days. Based on matching the statuses of the specialists with the priority of the status message, the system may refine the list of available specialists. Additionally, in an exemplary embodiment, updates to the availability of the specialists may be automatically generated in real-time by the review system.

In operation 903, it is checked if the refined list contains at least one specialist, if no, then the system may output an error message to the user in operation 904. For example, a pop up box may be provided indicating “Sorry, we could not find any specialists to match the criteria set forth in your review message.” The error message may further provide suggestions. For example, “The specialists in your network are not available for urgent review and are only available for ASAP review or regular review.” This message is provided by way of an example and not by way of a limitation. If there is at least one specialist remaining on the list in operation 903, the list is output as a drop down box in operation 905.

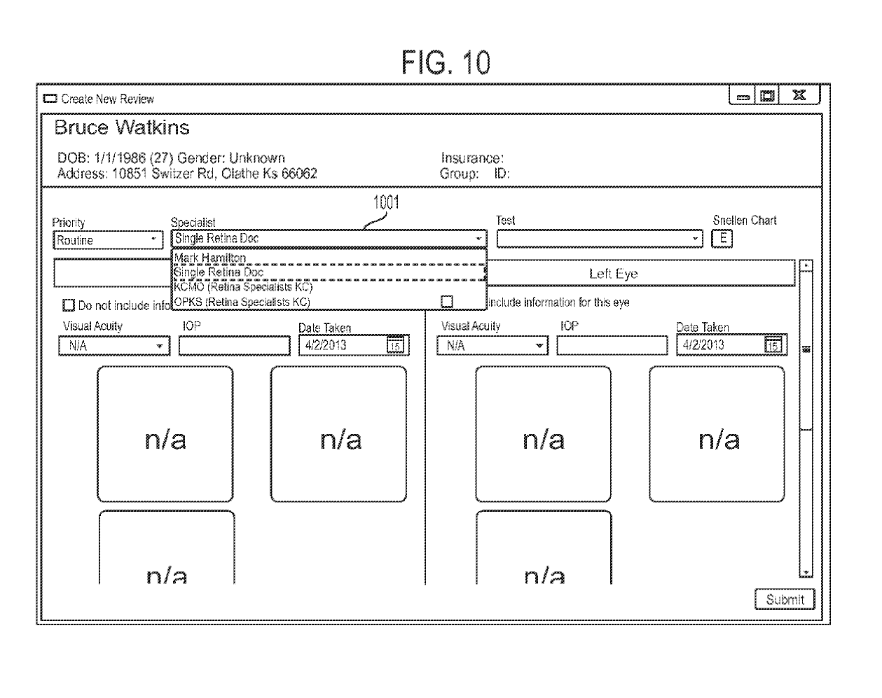

Referring back to FIG. 6, the user may then select a specialist in operation 605 via a drop down menu, as shown in FIG. 8, element 802. In an exemplary embodiment, the user may select an organization e.g., Retina Group or a particular Doctor within the Group via the drop down menu or via the pop up screens. FIG. 10 is a view illustrating a method of selecting a specialist according to an exemplary embodiment. In FIG. 10, a drop down box 1001 shows a mix of available specialists and practices. The user selects one of these options and next, proceeds with providing medical information necessary for the interpretation/analysis of the review message.

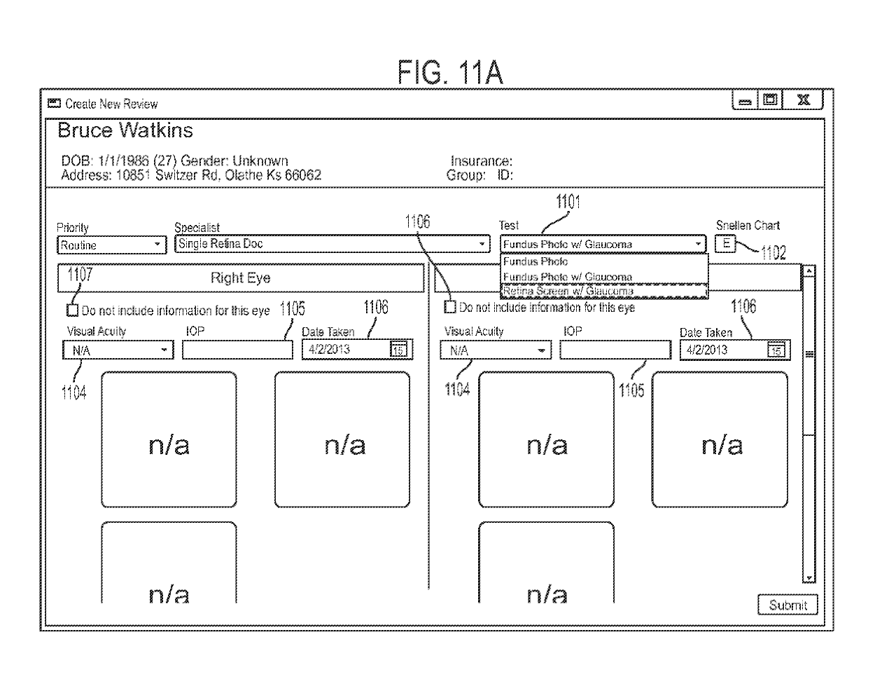

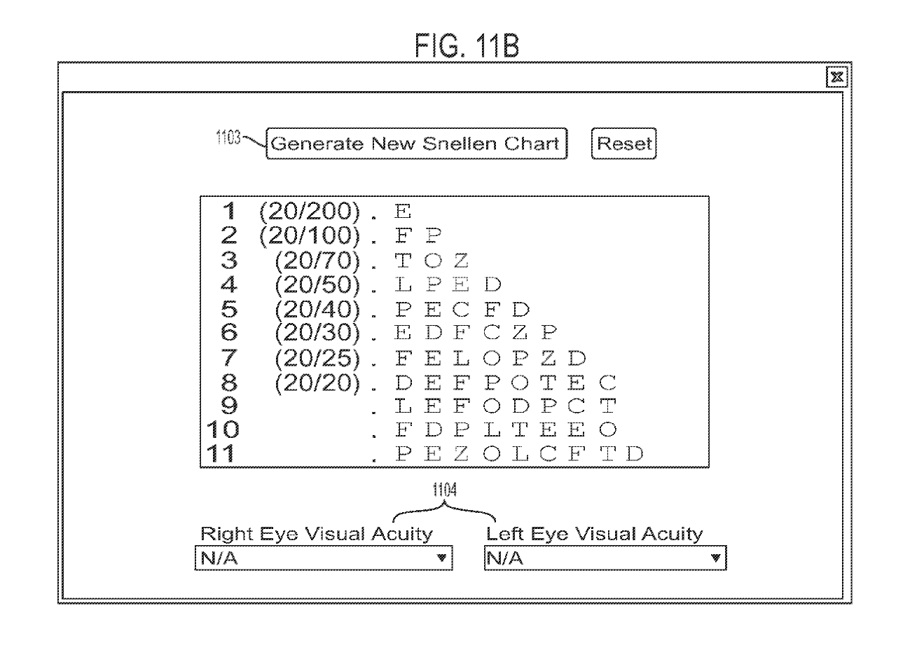

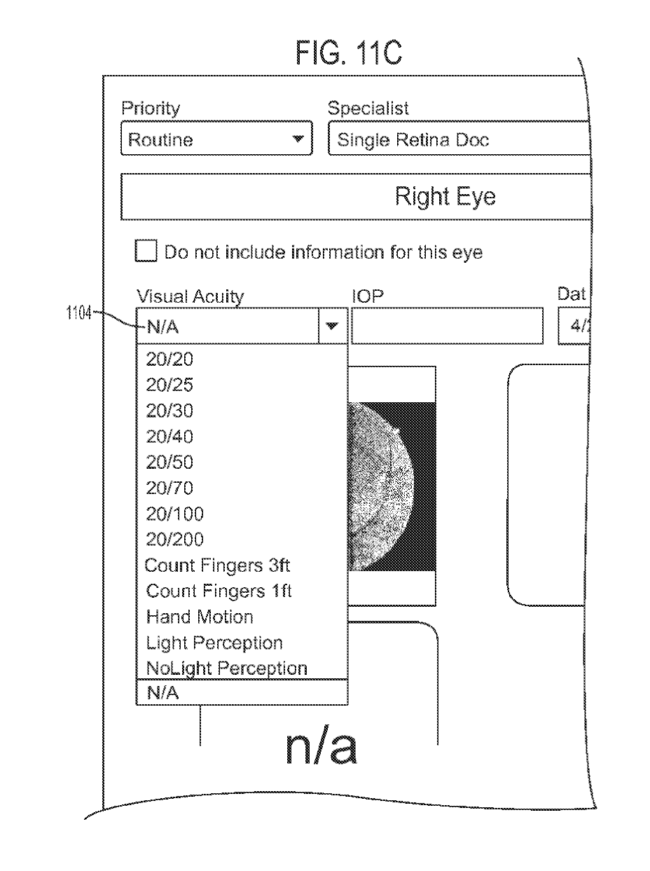

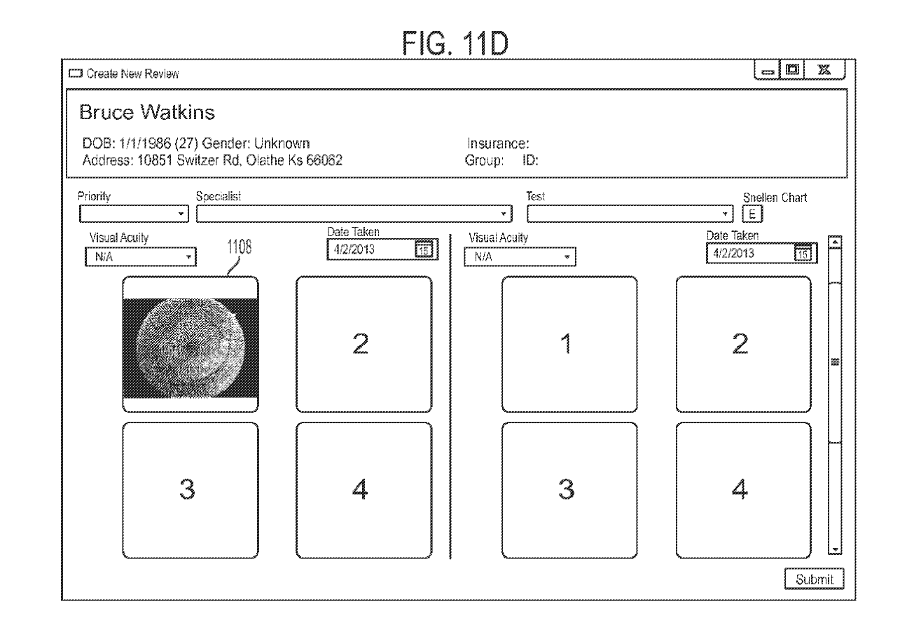

In operation 606, the user inputs medical information necessary for the review. FIGS. 11A-11C are views illustrating user interfaces for inputting review related information according to an exemplary embodiment. As shown in FIG. 11A, the user selects type of images provided and types of tests performed, field 1101. Field 1102 provides a Snellen Chart, so the user can perform a vision test. FIG. 11B is a view illustrating a user interface with an exemplary Snellen Chart, which may be regenerated by the user using field 1103. Further, field 1104 indicates values of visual acuity. FIG. 11C is a view illustrating a user interface for selecting visual acuity according to an exemplary embodiment. As shown in field 1104, in addition to selecting metric values, the user may select count fingers, hand motions, and light perception. These are provided by way of an example only and not by way of a limitation. The user may then input eye pressure (TOP) in the field 1105, as shown in FIG. 11A and the date for the tests in field 1106. This is provided by way of an example only. It is possible that at least some of these values may be auto-populated directly from the medical equipment. In an exemplary embodiment, the medical equipment may measure values and provide it to the PRN backend servers, which may then automatically populate fields such as IOP and date based on the information stored in the PRN backend servers. The user may select not to include one of the eyes by manipulating fields 1106 and 1107.

FIG. 11D is a view illustrating a user interface for inputting images according to an exemplary embodiment. As shown in FIG. 11D, the user may upload up to four images for each eye 1108. This is provided by way of an example only and not by way of a limitation. The images may be uploaded from a local drive or from the PRN database. In yet another exemplary embodiment, the review message may automatically be populated with images based on the patient information and test selected by the user. The user may further select an initial diagnosis from a drop down menu. That is, the referring entity may input what the condition they suspect the patient has, which needs to be confirmed by a specialist. Additional fields are provided for the user to input comments.

Referring back to FIG. 6, once the necessary medical information has been input, the PRN system waits for the user to submit the generated review message in operation 607. At any time, the user may go back and modify any of the input information. Once the generated review message is submitted (yes in operation 607), a formal letter may be generated and attached to the review message in operation 608. In an exemplary embodiment, the formal review letter may include a letter head and an electronic signature of the referring entity. Based on the generated review message, the letter may further be filled in with a) patient information, b) reasons for requesting the review, c) one or more conditions to review, and d) current date. In an exemplary embodiment, the formal review letter identifies the patient and the referring entity and request interpretation/review of the possible condition discovered by the referring entity. When the review message has been successfully submitted, a message is output to the user, in operation 609. In an exemplary embodiment, a message may be output on the screen indicating that the generated review message has been delivered to the designated one or more specialists for review.

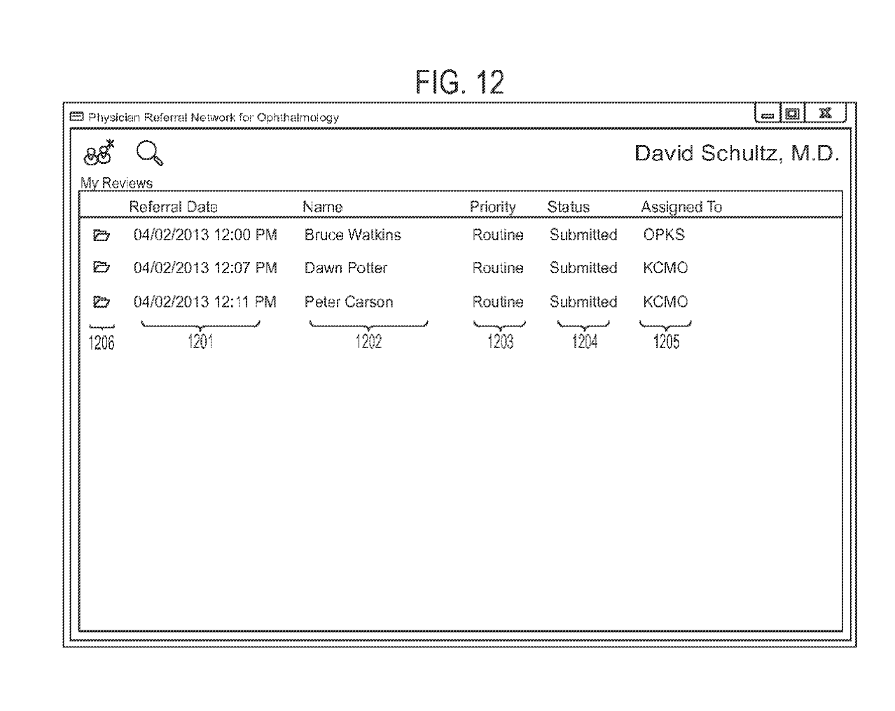

The PRN system may then return to a user interface showing the generated review messages and their respective statuses. FIG. 12 is a view illustrating a user interface for the generated review messages in a PRN system according to an exemplary embodiment. As shown in FIG. 12, each review may include a submission date and time 1201, name of the patient 1202, priority of the generated review message 1203, its status 1204, and the specialist to which the generated review message was sent 1205. The user may open and review the message 1206. The user may choose to edit/change certain fields and resubmit. In this case, a new review message is generated and added to the list. Further, the status of the generated review message 1204 may include “draft”—which is before it is submitted to the specialist, “submitted”—after the user submits the generated review message to a specialist, and “reviewed”—if response/results/an interpretation message has been received by the user.

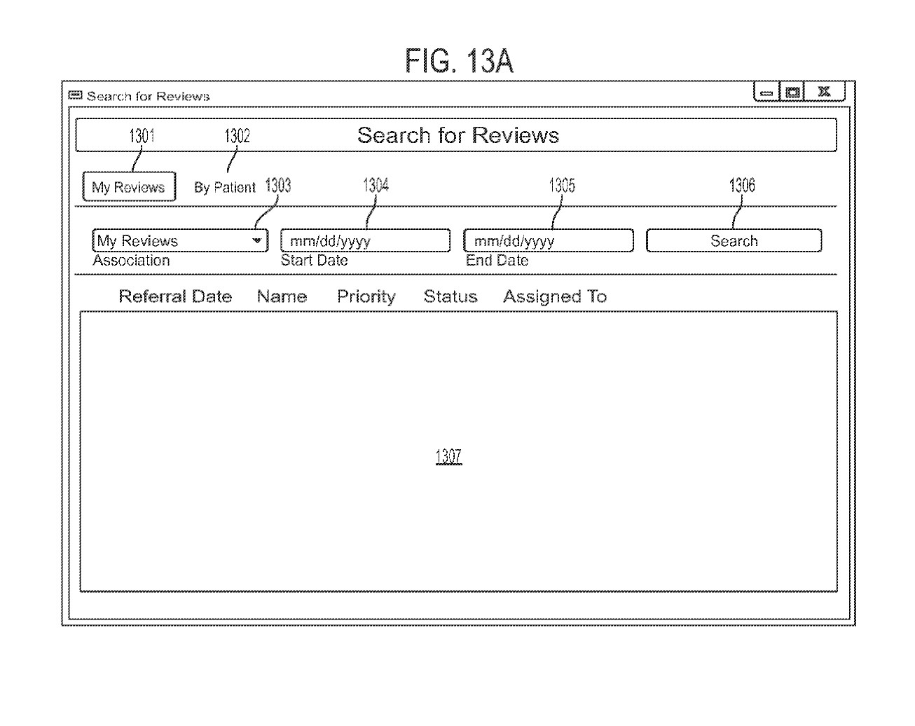

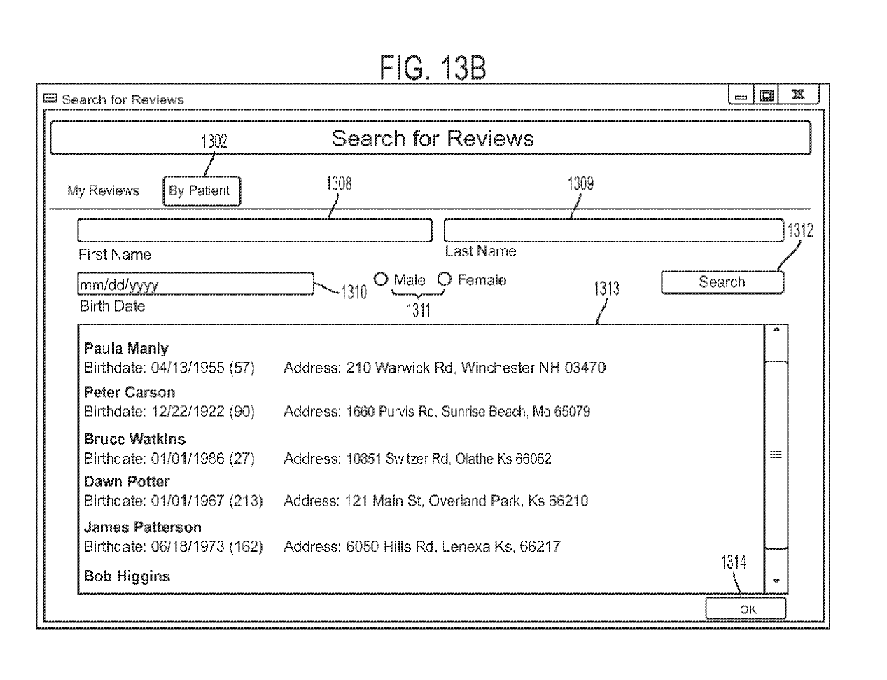

FIGS. 13A and B are views illustrating user interfaces for managing review messages according to an exemplary embodiment. As shown in FIG. 13A, the user may select to search in various folders. The user may select to search among his or her own reviews 1301 or may select to search for reviews for a particular patient or group of patients 1302. The user may input an association 1303, start date 1304 and end date 1305, and then select to search 1306. Search results appear in the box 1307.

As shown in FIG. 13B, the user may access archived review messages by selecting to search by patient or a group of patients 1302. The user may input patient first name 1308, last name 1309, birth date 1310, and gender 1311, as some of the exemplary search criteria items. The user may then select to search 1312. The results may be displayed in box 1313, the user may then select one or more of the review messages 1314 and delete, review, or edit i.e., generate new message with information of the selected message.

In exemplary embodiments, the referring entity such as a primary care physician may thus submit images and other test results for the review of a specialist to determine if a referral to the specialist is necessary. In exemplary embodiment, the situation 2 referral may thus be minimized and early diagnosis of diseases may be improved.

Interpretations—Reviewing Entity

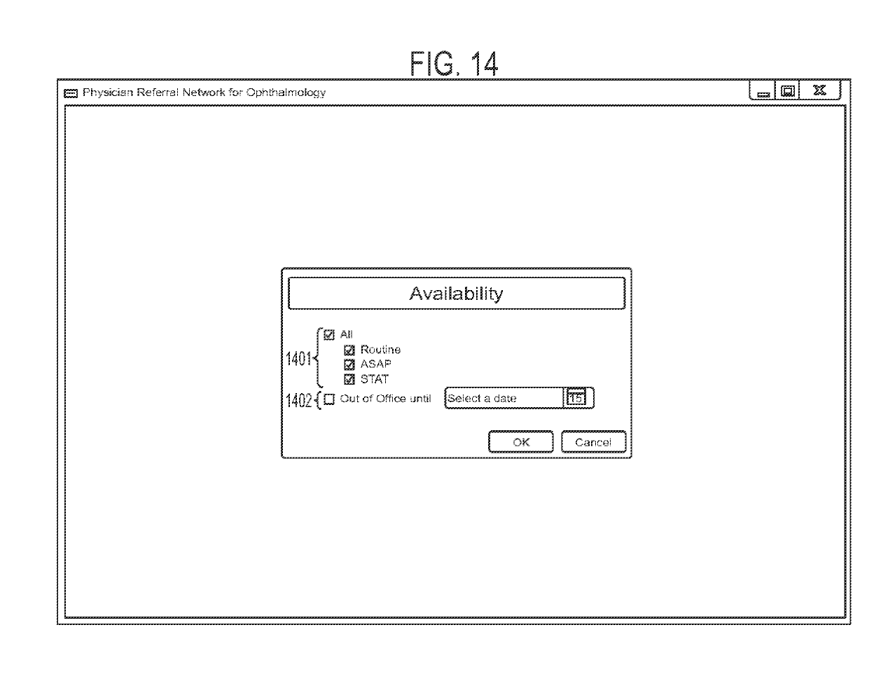

A reviewing entity such as a specialist needs to log into the system to review the generated review message. Each time the specialists logs in, they set their status which may be modified at any time while the specialist is logged into the system. FIG. 14 is a view illustrating a user interface for setting the status of the specialist according to an exemplary embodiment. As shown in FIG. 14, the specialist may set his availability 1401, set an out of office 1402. Although not shown, the specialist may also set a customized schedule for a predetermined number of days, weeks, or a month indicating his availability by various hours in each day. For example, the specialist may select his availability for only routine review messages on Mondays (because Mondays may be his surgery day). Further, the specialist may set Tuesday mornings 9:00 am to 1:30 pm for example as being available for routine and ASAP only as he may be teaching during this time and so on. One of ordinary skill in the art would readily appreciate that this is provided by way of an example only and not by way of a limitation.

In an exemplary embodiment, the specialist may be part of various groups and/or have several solo practices. Accordingly, the specialist may have several accounts with the PRN system, which allows the specialists to analyze different review messages that may have been submitted to one particular practice. The specialist may set his availability differently for each account or may have one availability for all accounts. The PRN system is flexible to allow the specialist to set different availabilities for different accounts or one to be applied for one or more accounts.

In yet another exemplary embodiment, the specialist may log in, select availability, and then select an organization for which the specialist is to analyze the review messages. Accordingly, one login provides access to various accounts/groups the specialist participates in. The specialist may then switch between various organizations as needed.

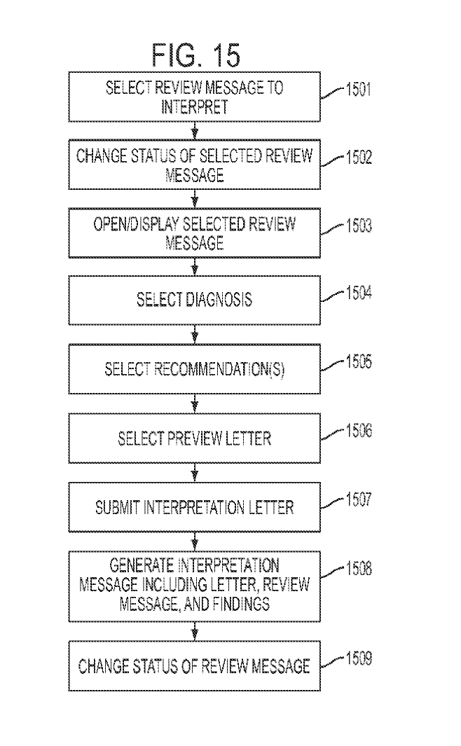

FIG. 15 is a flow chart illustrating a method of interpreting a review message according to an exemplary embodiment. In FIG. 15, in operation 1501, the specialist selects a submitted review message. In operation 1502, the status of the submitted review message changes to “in progress” indicating to other specialists and the referring entity that the message is being currently reviewed by the specialist. In operation 1503, the submitted review message is displayed to the specialist.

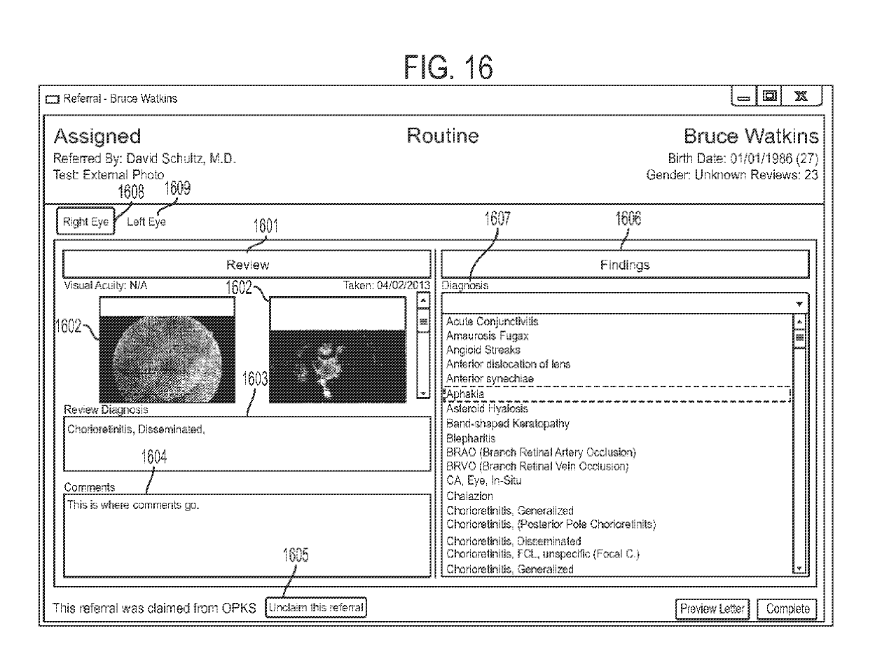

FIG. 16 is a view illustrating a user interface for a specialist to analyze the review message according to an exemplary embodiment. The review message is displayed on the left hand side 1601. The specialist may interpret information for each eye separately 1608 and 1609 via tabs. The specialist may select images 1602 to be viewed in the review message. The specialist may zoom in, change color, contrast, brightness, as needed, to accurately review the images 1602. The specialist may further interpret possible conditions or diagnosis suggested by the referring entity 1603 and any additional comments 1604. The specialist may further review the results of various tests and patient's vision and so on. The specialist may decide that the review cannot be completed by him at this time, and may un-claim the review message 1605. The review message may then return to the inbox to be claimed by another specialist. In an exemplary embodiment, the review message 1601 may be manipulated but the substance of it cannot be changed. The findings 1606 are for generating an interpretation message and are manipulatable by the specialist.

Referring back to FIG. 15, the specialist may then select a diagnosis in operation 1504. As shown in FIG. 16, the fields for generating the interpretation message are provided on the right hand side of the screen 1606. This is provided by way of an example only and not by way of a limitation. One of ordinary skill in the art would readily appreciate that other ways of structuring the presentation of information to the specialist are clearly within the scope of the present disclosure. The interpretation/findings may be selected by a specialist from a drop down menu of possible diagnosis/findings. In an exemplary embodiment, the PRN system reviews tests performed by the referring entity and based on the performed tests, selects various possible findings/conditions to appear in the drop down box.

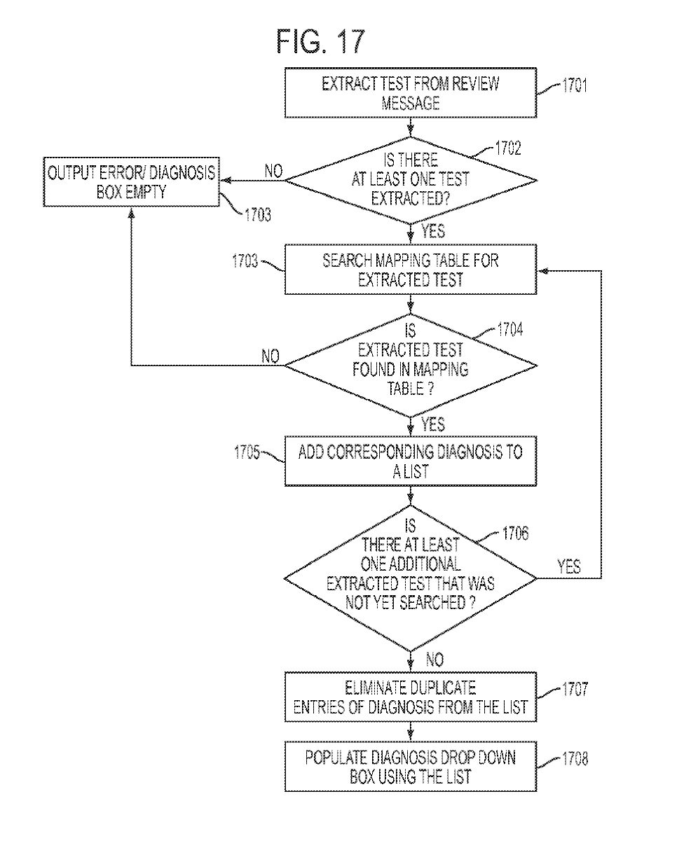

That is, as shown in FIG. 17, in operation 1701, the PRN system parses the review message to extract tests specified in the message. In an exemplary embodiment, the PRN system extracts tests selected by the referring entity. The PRN system then checks if at least one test is specified in operation 1702. If no tests are extracted, an error message may be output in operation 1703 and the diagnosis drop down box cannot be populated and remains blank. The specialist may then decide to proceed with the analysis of the message or may decide to respond to the review message indicating that no tests are specified and to refine the review message. This is provided by way of an example and not by way of a limitation.

If at least one test was extracted in operation 1702, the PRN system using backend servers searches for an extracted test in a mapping table in operation 1703. That is, the PRN system consults a knowledge base to find possible findings/conditions (diagnosis in FIG. 17) for each of the extracted tests. The PRN system using the backend servers accesses a mapping table stored in one of the databases. It is noted that a system may store a number of mapping tables and a mapping table may be selected based on the area of expertise of the specialist. The mapping table lists each test and the corresponding possible findings/diagnosis that can be made based on the test. Accordingly, the PRN system using one of the backend servers, searches for each of the extracted tests in the mapping table. If a test cannot be found in operation 1704, an error message 1703 is output.

If the test is found in the mapping table, corresponding possible conditions/diagnosis stored in the mapping table are added to a list, in operation 1705. That is, when the test is found in the mapping table, corresponding possible conditions/diagnosis are stored in a list. In an exemplary embodiment, the mapping table stores each test and corresponding possible conditions/diagnosis that can be made based on the test. Accordingly, when the test is found in the mapping table, the diagnosis linked to the test are extracted and stored in a list. In operation 1706, the PRN system checks if at least one other extracted test that has not yet been checked is present. If yes, the process returns to operation 1703 to search for this test in the mapping table.

If each of the extracted tests have been mapped to possible conditions/diagnosis using the mapping table (No in operation 1706), the duplicate diagnosis are eliminated from the stored list, in operation 1707. For example, the PRN system checks to eliminate any duplicate listings of the same diagnosis using a flag. The list is then used to populate the drop down box 1607 of the diagnosis 1606 in operation 1708. Accordingly, the specialist is provided with only relevant diagnosis for the review message.

Referring back to FIG. 15, the specialist selects one of the diagnoses from the custom populated drop down menu in operation 1504. In an exemplary embodiment, multiple diagnoses may be selected and/or added/deleted throughout the generating of the interpretation message. The specialist may also select one or more recommendations in operation 1505.

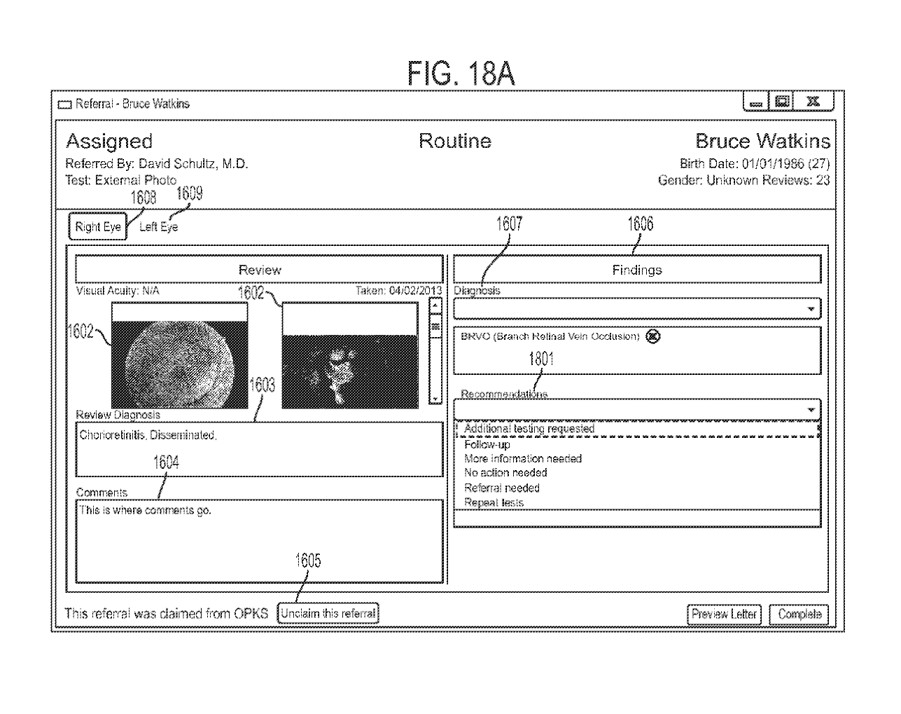

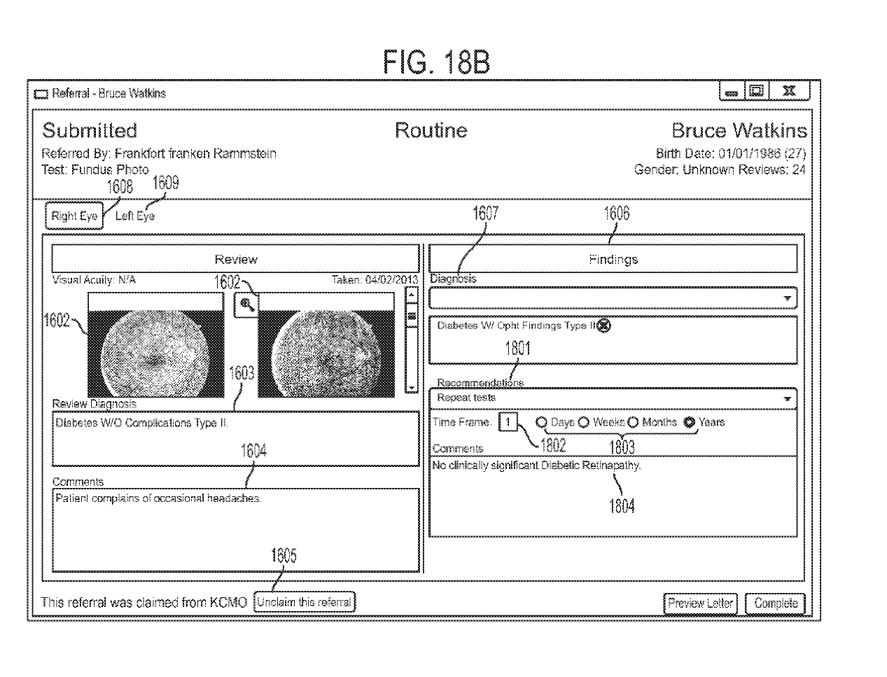

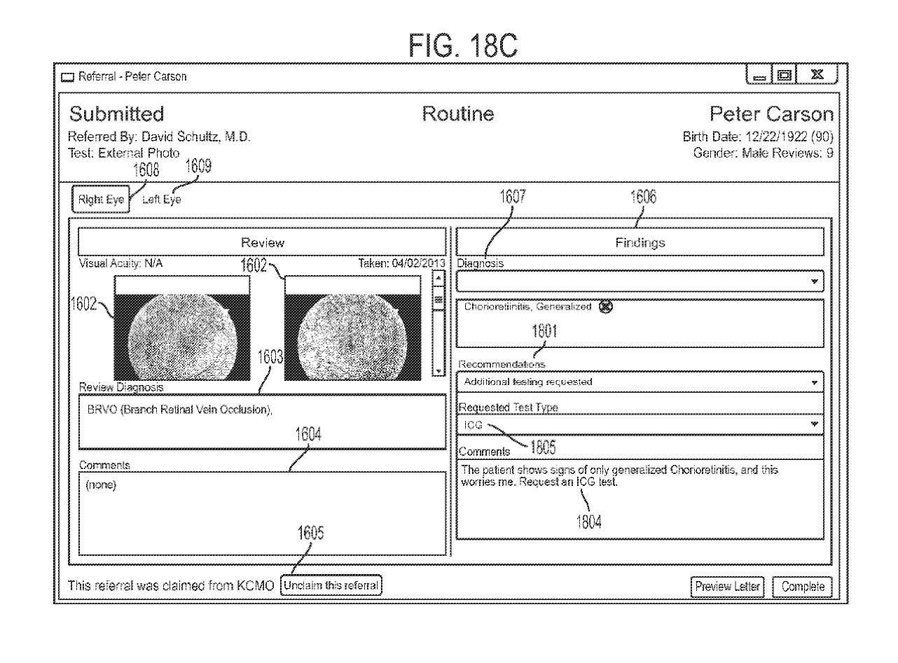

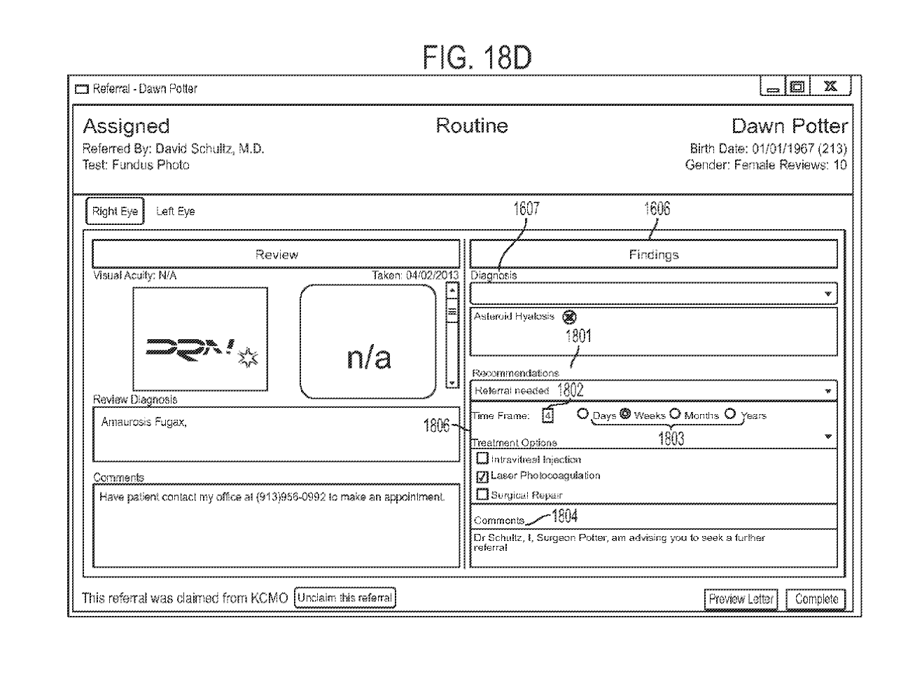

FIGS. 18A-18D are views illustrating user interfaces for selecting at least one recommendation according to an exemplary embodiment. As shown in FIG. 18A, the specialist may select one of the recommendation from a drop-down box 1801. The recommendations 1801 may include 1) repeat tests, 2) additional testing requested, 3) follow-up, 4) more information needed, 5) no action needed, and 6) a referral is needed.

In an exemplary embodiment, if the specialist recommends (1) repeating the test, time frame may further be specified 1802 and 1803, as shown in FIG. 18B. Additional comments may also be input 1804. For example, the specialist may request the test to be repeated within a year as a precaution or within a week, if the images did not upload correctly for example.

If the specialist may recommend (2) additional testing 1801, the specialist may further select a type of test 1805 from a drop down menu and input additional comments 1804, as shown in FIG. 18C.

If the specialist recommends (3) to follow up, the time frame analogous to the one shown in FIG. 18B may be input. In the additional comments 1804, the specialist may further explain why a follow up is needed and what to look for during the follow up and which tests to repeat if any. For example, the specialist may recommend a repeat tests in 3 months i.e., a particular non-clinically significant condition was noted, but needs to be monitored by making notes in the additional comments 1804, and then suggest a repeat test so that the referring entity can check if the problem changes from baseline, and may therefore warrant a referral to the specialist in later visits to the referring entity.

The specialist may recommend (4) more information needed. The specialist would then indicate additional information that is required in the comments 1804. For example, the specialist may indicate that images of the right eye are blurry and retake is necessary.

The specialist may recommend (5)—no action needed. Thereby, situation 2 discussed in the related art may be avoided. That is, based on the findings, the specialist believes that no further action is necessary and there is no condition that would require specialist's attention. The specialist may further include comments in 1804.

The specialist may recommend (6) a referral is needed. As shown in FIG. 18D, the specialist may input time frame for the referral 1802 and 1803. The user may further input some proposed treatment options 1806 and provide additional comments 1804.

Referring back to FIG. 15, the interpretation message has now been completed by the specialist. The specialist may then select to preview the letter in operation 1506. In an exemplary embodiment, the letter may be generated based on the findings input in operations 1504-1506 as described above.

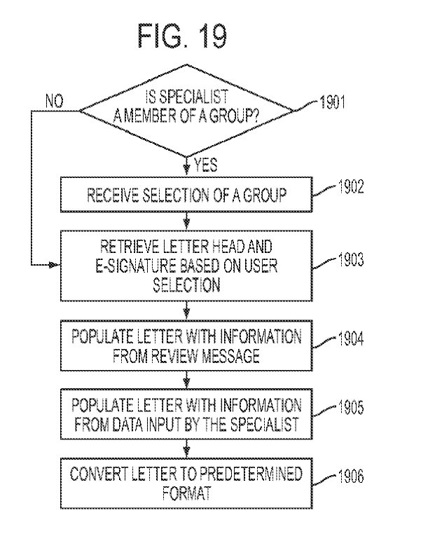

FIG. 19 is a flow chart illustrating a method of generating an interpretation letter according to an exemplary embodiment. As shown in FIG. 19, in operation 1901, if a specialist is a member group of specialists. If the specialist is a member of a group of specialists (1901—yes), an exemplary embodiment asks the specialist to select the particular group that is desired to set the context for this review in operation 1902, including the specific group letter head to use, and provider digital signature. In an exemplary embodiment, the letter head and digital signature is retrieved from the datastore based on the selected group or based on whether the specialist is a solo practitioner, in operation 1903.

The letter head may be customized for each specialist group in the practice or may be one letter head for the practice.

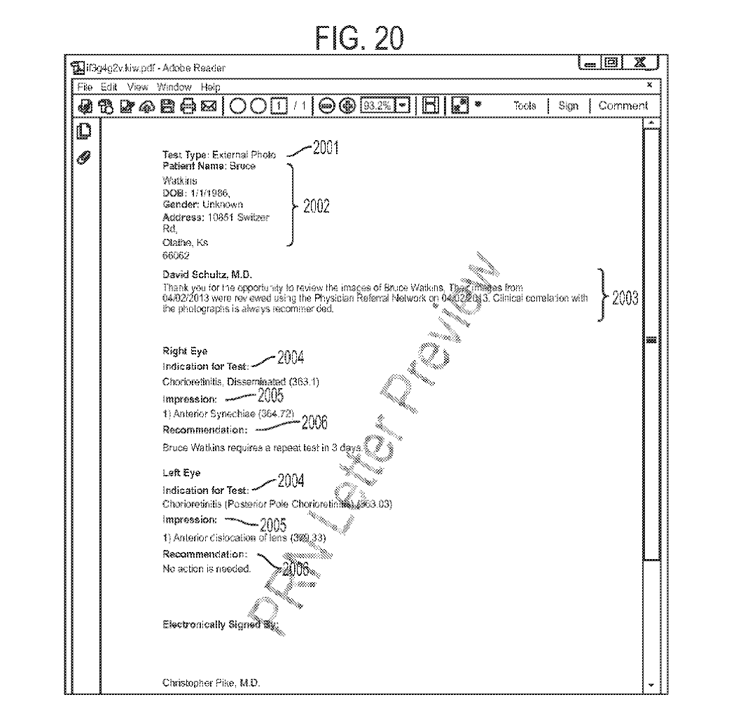

The letter may then be populated with patient information and the test type performed based on information provided in the review message, in operation 1904. FIG. 20 is a view illustrating a generated interpretation letter according to an exemplary embodiment. As shown in FIG. 20, the test type 2001 and patient information 2002 is listed.

In operation 1905, the letter may be populated with information input by the specialists from the diagnosis, comments, and recommendations. As shown in FIG. 20, for example, the specialist comments may be provided 2003; it is possible that additional auto text may be added to the comments such as “thank you for the opportunity to review” or “thank you for using PRN”, etc. Further, the letter may include indication from the test 2004 (based on the review message), diagnosis 2005, and recommendations 2006. Further, each eye is addressed separately, as shown in FIG. 20. For each eye as, as described in this exemplary embodiment, the initial indication for the review from the referring entity (Indication for test) is documented, as well as the impression as identified by the specialist. Further, each eye may also contain any comments as detailed by the specialist during the review process.

In operation 1906, the letter is converted to a predetermined format such as .pdf and signature is added. Accordingly, an interpretation letter is generated based on information pre-stored for the account (practice group or solo specialist), information provided in the received review message, and findings input by the specialist.

The specialist may not need to preview the letter and may simply submit the findings without preview in operation 1507, as shown in FIG. 15. When findings are submitted, an interpretation message is generated in operation 1508. To generate an interpretation message, information of the review message, the findings, and the generated letter are added to the message and the message is submitted to the PRN system. In operation 1509, the status of the review message is changed to “reviewed”.

In an exemplary embodiment, the referring entity is notified of the status change of the message via a predetermined method such as SMS, automated telephone call, changing appearance of the review message in the inbox e.g., presenting the review message in bold to indicate that findings have been added. When the referring entity opens the review message, both sides (the review side and the findings) and completed. The referring entity cannot make changes to either sides of the review message but may select to view/print the letter generated by the specialist in addition to reviewing his or her finding. The user then further changes the status of the review message to “completed”. Once the review message is marked completed, it is deleted from the inbox and is archived to one of the archive databases.

In an exemplary embodiment, the review message includes insurance information, which may be used by the referring entity and/or the specialist to bill for services rendered. In addition, in an exemplary embodiment, it is possible that one entity may have dual roles: referring entity role and the reviewing entity role. For example, the inbox of the dual role entity may be split such that one portion of the screen provides a to-do-list filled with review messages that the dual role entity needs to analyze and interpret. Another portion of the screen may provide the review messages generated or in the process of being generated by the dual-role entity. Accordingly, in an exemplary embodiment, the dual-role entity may view both: generated review messages that have been submitted and the review messages that need to be analyzed.

In exemplary embodiments, reviews/diagnosis performed remotely by a specialist are made to determine if a referral is necessary. Situation 2 described in the related art is minimized. Further, the referring entity remains in contact with the patient, and thus, there is less of a fear of losing the patient and specialist is consulted as needed. Additionally, the patient obtains the initial expertise of the specialist without the lengthy referral process. Further, early diagnosis of diseases is improved.

Various exemplary components of the reviewing (PRN) system have been described above in various exemplary embodiments. The review (PRN) system may be an integrated system or each component may be separately used with other system. In an exemplary embodiment, a particular component of the system may be embedded in another system.

The flowchart and block diagrams in the Figures illustrate the architecture, functionality, and operation of possible implementations of systems, methods and computer program products according to various exemplary embodiments. In this regard, each block in the flowchart or block diagrams may represent a module, segment, or portion of code, which comprises one or more executable instructions for implementing the specified logical functions. It should also be noted that, in some alternative implementations, the functions noted in the block may occur out of the order noted in the figures. For example, two blocks shown in succession may, in fact, be executed substantially concurrently, or two blocks may sometimes be executed in the reverse order, depending upon the functionality involved. It will also be noted that each block of the block diagram and/or flowchart illustration, and combinations of blocks in the block diagrams and/or flowchart illustration, can be implemented by special purpose hardware-based systems that perform the specified functions or acts, or combinations of special purpose hardware and computer instructions.

The corresponding structures, materials, acts, and equivalents of all means or step plus function elements in the claims below are intended to include any structure, material, or acts for performing the function in combination with other claimed elements as specifically claimed. The description of the exemplary embodiments has been presented for purposes of illustration and description, but is not intended to be exhaustive or limiting in the form disclosed. Many modifications and variations will be apparent to those of ordinary skill in the art without departing from the scope and spirit of the inventive concept. The exemplary embodiments were chosen and described in order to best explain the principles and the practical application, and to enable others of ordinary skill in the art to understand the inventive concept for various embodiments with various modifications as are suited to the particular use contemplated.

One exemplary embodiment resides in a computer system. Here, the term “computer system” is to be understood to include at least a memory and a processor. In general, the memory will store, at one time or another, at least portions of an executable program code, and the processor will execute one or more of the instructions included in that executable program code. It will be appreciated that the term “executable program code” and the term “software” mean substantially the same thing for the purposes of this description. It is not necessary to the practice one or more exemplary embodiments that the memory and the processor be physically located in the same place. That is to say, it is foreseen that the processor and the memory might be in different physical pieces of equipment or even in geographically distinct locations.

One exemplary embodiment also has a user interface invocable by an application program. A user interface may be understood to mean any hardware, software, or combination of hardware and software that allows a user to interact with a computer system. For the purposes of this discussion, a user interface will be understood to include one or more user interface objects. User interface objects may include display regions, user activatable regions, and the like. As is well understood, a display region is a region of a user interface which displays information to the user. A user activatable region is a region of a user interface, such as a button or a menu, which allows the user to take some action with respect to the user interface.

A user interface may be invoked by an application program. When an application program invokes a user interface, it is typically for the purpose of interacting with a user. It is not necessary, however, for the purposes of the inventive concept that an actual user ever interact with the user interface. It is also not necessary, for the purposes of the inventive concept, that the interaction with the user interface be performed by an actual user. That is to say, it is foreseen that the user interface may have interaction with another program, such as a program created using macro programming language statements that simulate the actions of a user with respect to the user interface.

Exemplary embodiments were chosen and described in order to explain operations and the practical application, and to enable others of ordinary skill in the art to understand various exemplary embodiments with various modifications as are suited to the particular use contemplated. That is, various modifications to these exemplary embodiments will be readily apparent to those skilled in the art, and the generic principles and specific examples defined herein may be applied to other embodiments without the use of inventive faculty. For example, some or all of the features of the different exemplary embodiments discussed above may be combined into a single embodiment. Conversely, some of the features of a single exemplary embodiment discussed above may be deleted from the embodiment. Therefore, the inventive concept is not intended to be limited to the exemplary embodiments described herein but is to be accorded the widest scope as defined by the limitations of the claims and equivalents thereof.

What is claimed is:

1. A method of providing medical review, the method comprising:
selecting by a user at least one reviewer from a list of available reviewers;
setting a priority for a reply;
generating, by a computer, a review message comprising metadata of a patient, obtained by a plurality of events performed on a part of the patient, the set priority, and an identification of the selected reviewer;
transmitting the generated review message over a guaranteed network; and
receiving an interpretation message over the guaranteed network based on the transmitted review message,
wherein the list of available reviewers is generated in real time based on the set priority and the current availability of the reviewer.

2. The method of claim 1, wherein the generating of the list of available reviewers comprises:
determining, in real time, status of each of a plurality of reviewers in a directory of the user; and
determining whether said each of the plurality of reviewers is able to generated the interpretation message to meet the set priority based on the determined status.

3. The method of claim 1, wherein the interpretation message comprises interpreted information generated by the selected reviewer, from a list of recommendations and plans based on the data provided in the review message.

4. The method of claim 3, wherein the recommendation is selected from a list of available recommendation options that are identified based on the events provided in the review message.

5. The method of claim 1, wherein the metadata of the patient comprises type of test performed on the part of the patient and at least one of metric data and images showing the results of the tests.

6. The method of claim 1, wherein the part of the patient is at least one eye and wherein the plurality of events comprise eye related tests.

7. A method of providing medical review, the method comprising:
receiving a review message comprising metatdata of a patient containing a plurality of events performed on a part of the patient, a priority, and an identification of at least one reviewer;
analyzing, by a computer, the review message in which available recommendations are identified based on the events performed;
generating an interpretation message which comprises a recommendation selected from the identified available recommendation options by a reviewer; and
transmitting the generated interpretation message over a network.

8. The method of claim 7, wherein the analyzing of the review message further comprises: automatically assigning a status identifier to the received review message,
wherein, if one reviewer is identified in the review message, assigning an assigned status to the review message and notifying the reviewer of the received review message, and
wherein, if at least two reviewers are identified in the review message, assigning a submitted status to the review message and notifying the at least two reviewers of the received review message and wherein, when one of the at least two reviewers claims the review message, assigning the assigned status to the review message.

9. The method of claim 8, further comprising:
receiving input from the reviewer of the at least two reviewers with respect to the review message;
changing status of the review message to the assign status based on the input from the reviewer; and
changing status of the review message to reviewed status after the generating of the interpretation message.

10. The method of claim 9, wherein the changed status of the review message is updated in real time and the updated review message is displayed in a reviewer user interface and in a submitter entity user interface.

11. The method of claim 7, wherein:
the part of patient body comprises at least one eye and the plurality of events comprise at least one eye related test,
the metadata further comprises at least one type of the eye related test;
the identifying of the available recommendations comprises:
searching for one of the at least one type of the eye related test in a mapping table;
if said one type of eye related test is found in the mapping table, obtaining at least one corresponding available recommendations;
adding the obtained at least one corresponding available recommendations as the identified available recommendations.

12. The method of claim 7, wherein the generating the interpretation message further comprises adding treatment information indicating whether a referral to the reviewer is necessary.

13. The method of claim 7, wherein the generating the interpretation message further comprises selecting at least one treatment from a list of available treatments comprising no referral is necessary, a follow up is needed within a preset time period, more information is needed, at least one of the plurality of events needs to be repeated within the preset time period, and a referral is needed comprising proposed treatment options.

14. The method of claim 7, wherein the generating the interpretation message comprises generating a letter comprising at least a portion of the metadata from the review message, at least a portion of the information from the generated interpretation message, and metadata of the reviewer comprising at least one of customized letter head and an electronic signature.

15. An apparatus of generating a review message, the apparatus comprising:
a memory storing a plurality of reviewers;
a communication interface configured to receive a selection of at least one reviewer from a list of available reviewers and a priority for a reply selected by a user; and
a processor configured to generate a review message comprising metadata of a patient, obtained by a plurality of events performed on a part of the patient, the received priority, and an identification of the received, selected reviewer;
wherein the communication interface transmits the generated review message over a guaranteed network and receives an interpretation message over the guaranteed network based on the transmitted review message, and
wherein the list of available reviewers is generated from the stored plurality of reviewers in real time based on the set priority and current availability of the reviewer.

16. The apparatus of claim 15, wherein the processor determines, in real time, status of each of a plurality of reviewers in a directory of the user and determines whether said each of the plurality of reviewers is able to generated the interpretation message to meet the set priority based on the determined status.

17. The apparatus of claim 15, wherein the interpretation message comprises interpreted information generated by the selected reviewer, from a list of recommendations and plans based on the data provided in the review message.

18. The apparatus of claim 17, wherein the recommendation is selected from a list of available recommendation options that are identified based on the events provided in the review message.

19. The apparatus of claim 17, wherein the metadata of the patient comprises type of test performed on the part of the patient and at least one of metric data and images showing the results of the tests.

20. The apparatus of claim 17, wherein the part of the patient is at least one eye and wherein the plurality of events comprise eye related tests.

21. An apparatus of providing medical review, the apparatus comprising:
a communication interface configured to receive a review message comprising metadata of a patient containing a plurality of events performed on a part of the patient, a priority, and an identification of at least one reviewer;
a processor configured to analyze the review message in which available recommendations are identified based on the events performed and configured to generate an interpretation message which comprises a recommendation selected from the identified available recommendation options by a reviewer,
wherein the communication interface transmits the generated interpretation message over a network.

22. The apparatus of claim 21, wherein the processor automatically assigning a status identifier to the received review message,
wherein, if one reviewer is identified in the review message, the processor assigns an assigned status to the review message and controls the communication interface to notify at least one device of the reviewer of the received review message, and
wherein, if at least two reviewers are identified in the review message, the processor assigns a submitted status to the review message and controls the communication interface to notify at least one device of each of the at least two reviewers of the received review message and when one of the at least two reviewers claims the review message, the processor assigns the assigned status to the review message.

23. The apparatus of claim 22, wherein the communication interface receives input from the reviewer of the at least two reviewers with respect to the review message,
wherein the processor changes status of the review message to the assign status based on the input from the reviewer; and changes status of the review message to reviewed status after the generating of the interpretation message.

24. The apparatus of claim 23, wherein:
the processor changes the status of the review message in real time,
the part of patient body comprises at least one eye and the plurality of events comprise at least one eye related test,
the metadata further comprises at least one type of the eye related test, and
the processor identifies the available recommendations by:
searching for one of the at least one type of the eye related test in a mapping table;
if said one type of eye related test is found in the mapping table, obtaining at least one corresponding available recommendations, and
adding the obtained at least one corresponding available recommendations as the identified available recommendations.

25. The apparatus of claim 21, wherein the processor adds treatment information indicating whether a referral to the reviewer is necessary to the review message.

26. The apparatus of claim 21, wherein the processor selects at least one treatment from a list of available treatments comprising no referral is necessary, a follow up is needed within a preset time period, more information is needed, at least one of the plurality of events needs to be repeated within the preset time period, and a referral is needed comprising proposed treatment options.

27. The apparatus of claim 21, wherein the processor generates a letter comprising at least a portion of the metadata from the review message, at least a portion of the information from the generated interpretation message, and metadata of the reviewer comprising at least one of customized letter head and an electronic signature and attaches the generated letter to the interpretation message.

28. A non-transitory computer readable medium storing therein the method of claim 1.

29. A non-transitory computer readable medium storing therein the method of claim 7.

30. A system of providing medical review, the system comprising:
a first device for generating a medical review message, the first device comprising:
a first communication interface configured to receive a selection of at least one reviewer from a list of available reviewers and a priority for a reply selected by a user, configured to transmit a review message over a guaranteed network and receive an interpretation message over the guaranteed network based on the transmitted review message; and
a first processor configured to generate the review message comprising metadata of a patient, obtained by a plurality of events performed on a part of the patient, the received priority, and an identification of the received, selected reviewer; and
a second device for providing medical review in response to the review message, the second device comprising:
a second communication interface configured to receive the review message from the first device and transmit an interpretation message over the guaranteed message in response to the review message; and
a second processor configured to analyze the review message in which available recommendations are identified based on the events performed and configured to generate the interpretation message which comprises a recommendation selected from the identified available recommendation options by a reviewer,
wherein the list of available reviewers is generated from the stored plurality of reviewers in real time based on the set priority and current availability of the reviewer.
